(19) United States
(12) Patent Application Publication
(10) Pub. No.: US 2023/0226482 A1
(43) Pub. Date: Jul. 20, 2023

(54) FILTER SYSTEMS FOR TREATING AIR AND METHODS OF USE THEREOF

(71) Applicant: ICA TriNova, LLC, Newnan, GA (US)

(72) Inventors: Steven Beers, Newnan, GA (US); Joel Tenney, Marietta, GA (US)

(21) Appl. No.: 18/095,648

(22) Filed: Jan. 11, 2023

Related U.S. Application Data
(60) Provisional application No. 63/300,496, filed on Jan. 18, 2022.

(51) Int. Cl. B01D 53/00; B01D 46/00

(52) U.S. Cl. CPC B01D 53/00; B01D 46/0036; B01D 2253/10; B01D 2313/2031; B01D 2313/042; B01D 2313/28; B01D 2257/91; B01D 2257/70; B01D 2259/122

(57) ABSTRACT

Disclosed herein are systems and methods for treating air.

### CROSS-REFERENCE TO RELATED APPLICATIONS

This application claims the benefit of priority to U.S. Provisional Application No. 63/300,496 filed Jan. 18, 2022, which is hereby incorporated herein by reference in its entirety.

### BACKGROUND

Systems and methods for treating air and/or surfaces, for example to reduce the activity (e.g., contagiousness and/or infectiousness) and/or transmission of bioaerosols containing infectious microbials such as coronaviruses, are needed. The systems and methods discussed herein address these and other needs.

### SUMMARY

In accordance with the purposes of the disclosed systems and methods, as embodied and broadly described herein, the disclosed subject matter relates to systems and methods for treating air.

For example, disclosed herein are filter systems for treating air, the filter systems comprising: a first filter comprising a media; wherein air directed to flow through the filter system contacts the first filter; wherein the media is configured to generate a treatment gas from a precursor, such that the treatment gas is released into the flow path of the air; and wherein the treatment gas comprises chlorine dioxide (ClO₂) and the precursor comprises a chlorine dioxide precursor, the treatment gas comprises carbon dioxide (CO₂) and the precursor comprises a carbon dioxide precursor, or a combination thereof.

In some examples, the filter systems can further comprise a second filter sequentially arranged relative to the first filter along the direction of air flow. In some examples, the second filter comprises a coarse filter, a fine filter, a semi-HEPA filter, a HEPA filter, a ULPA filter, or a combination thereof. In some examples, the second filter comprises an activated carbon filter.

In some examples, the treatment gas comprises chlorine dioxide and the precursor comprises a chlorine dioxide precursor. In some examples, the chlorine dioxide precursor comprises a chlorine dioxide-producing compound selected from the group consisting of a metal chlorite, a metal chlorate, chloric acid, hypochlorous acid, and combinations thereof. In some examples, the metal chlorite comprises sodium chlorite, barium chlorite, calcium chlorite, lithium chlorite, potassium chlorite, magnesium chlorite, or combinations thereof. In some examples, the metal chlorate comprises sodium chlorate, lithium chlorate, potassium chlorate, magnesium chlorate, barium chlorate, or combinations thereof.

In some examples, the treatment gas comprises carbon dioxide and the precursor comprises a carbon dioxide precursor. In some examples, the carbon dioxide precursor comprises a carbon-containing compounds selected from the group consisting of carbonates, bicarbonates, sesquicarbonates, and combinations thereof. In some examples, the carbon-containing compound is selected from the group consisting of sodium carbonate, sodium bicarbonate, sodium sesquicarbonate, and combinations thereof.

In some examples, the media comprises dry particles comprising the precursor. In some examples, the dry particles comprising the precursor further comprise a porous carrier selected from the group consisting of zeolite crystals, silica, pumice, diatomaceous earth, bentonite, and clay, and wherein the precursor is impregnated in the porous carrier. In some examples, the porous carrier has an average particle size of from 0.5 micrometers (microns, μm) to 25.4 millimeters (mm). In some examples, the dry particles comprising the precursor include from 1% to 100%, from 1% to 90%, or from 1% to 50% by weight of the precursor.

In some examples, the media further comprises a proton generating species. In some examples, the media further comprises dry particles comprising the proton-generating species. In some examples, the proton-generating species comprises an organic acid, an inorganic acid, a metal salt, or a combination thereof. In some examples, the proton-generating species comprises an organic acid and/or an inorganic acid selected from the group consisting of acetic acid, citric acid, hydrochloric acid, phosphoric acid, propionic acid, sulfuric acid, and combinations thereof. In some examples, the proton-generating species comprises a metal salt selected from the group consisting of ferric chloride, ferric sulfate, CaCl₂, ZnSO₄, ZnCl₂, CoSO₄, CoCl₂, MnSO₄, MnCl₂, CuSO₄, CuCl₂, MgSO₄, sodium acetate, sodium citrate, sodium sulfate, sodium bisulfate, hydrogen phosphate, disodium hydrogen phosphate, and combinations thereof. In some examples, the dry particles comprising the proton-generating species further comprise a porous carrier selected from the group consisting of zeolite crystals, silica, pumice, diatomaceous earth, bentonite, and clay, and wherein the proton-generating species is impregnated in the porous carrier. In some examples, the porous carrier has an average particle size of from 0.5 micrometers (microns, μm) to 25.4 millimeters (mm). In some examples, the dry particles comprising the proton-generating species include from 1% to 100%, from 1% to 90%, or from 1% to 50% by weight of the dry particles of the proton-generating species.

In some examples, the media is disposed within the first filter with an average total thickness of from 1 cm to 50 cm.

In some examples, the media is disposed within the first filter as a mixture of the dry particles of comprising the precursor and the dry particles comprising the proton generating species.

In some examples, the media is disposed within the first filter as a layered bed comprising two or more alternating layers of the dry particles comprising the precursor and the dry particles comprising the proton-generating species. In some examples, the total number of layers in the layered bed is from 3 layers or more. In some examples, the average thickness of each of the layers of dry particles comprising the precursor and/or the average thickness of each of the layers of dry particles comprising the proton-generating species is independently from 1 cm to 50 cm.

In some examples, the first filter further comprises a grid structure disposed throughout the first filter. In some examples, the grid structure comprises a plurality of wells and the media is disposed within the plurality of wells.

In some examples, the first filter further comprises a frame defining the perimeter of the first filter.

In some examples, the first filter further comprises a permeable layer defining a surface of the first filter, wherein the frame and the permeable layer together define a volume and the media is at least partially enclosed or contained within the volume. In some examples, the permeable layer is bonded to the frame via an adhesive.

In some examples, the first filter further comprises a first permeable layer defining a top surface of the first filter and a second permeable layer defining a bottom surface of the first filter, such that the frame, the first permeable layer, and the second permeable layer together define a volume and the media is enclosed within the volume. In some examples, the first permeable layer and the second permeable layers are bonded to the frame via an adhesive.

In some examples, air is directed to flow through the filter system at a flow rate of from 1 cfm to 1,000 cfm (e.g., from 250-500 cfm).

In some examples, the media generates the treatment gas at a rate from 0.1 to 600 milligrams of treatment gas per day per gram of precursor initially present (e.g., from 0.1 to 60).

In some examples, the air exits the filter system and flows into a chamber having a volume and the first filter releases the treatment gas into the flow path of the air such that the concentration of the treatment gas within the volume of the chamber is 1 ppmv or less.

In some examples, the media comprises an electrostatically charged surface.

In some examples, the air has a humidity of from 20% to 90% or from 50% to 80%.

In some examples, the air directed through the filter system comprises a first component in a first amount before entering the filter system. In some examples, the first component comprises a toxin, a contaminant, a warfare agent, or a combination thereof. In some examples, the first component comprises an organic molecule, a biological agent, or a combination thereof. In some examples, the first component comprises a pathogen, such as an infectious microbe. In some examples, the filter system reduces the amount of the first component in the air, such that the air exiting the filter system has a lower amount of the first component relative to the air entering the filter system. In some examples, the filter system substantially removes the first component from the air. In some examples, the first component comprises a pathogen and the filter system reduces the activity of the pathogen. In some examples, the first component comprises an organic molecule and the first filter oxidizes the first component.

Also disclosed herein are methods of use of any of the filter systems disclosed herein, for example to treat air. In some examples, the method comprises reducing the transmission of bioaerosols containing infectious microbials. In some examples, the method comprises air purification, environmental remediation, or a combination thereof. In some examples, the air exiting the filter system is treated relative to the air entering the filter system. In some examples, the method comprises treating ambient air within a chamber having a volume by releasing the treatment gas generated by the media into the chamber. In some examples, the chamber is provided within a building. In some examples, the filter system releases an amount of the treatment gas into the chamber, such that the concentration of the treatment gas within the volume of the chamber is 1 ppmv or less.

Also disclosed herein are methods for of treating a disease or disorder in a subject in need thereof, the methods comprising administering to the subject a therapeutically effect amount of the treatment gas generated by any of the filter systems disclosed herein. In some examples, the method comprises delivering a therapeutically effective amount of the treatment gas to at least a portion of the respiratory tract of the subject. In some examples, the subject inhales the therapeutically effective amount of the treatment gas. In some examples, the filter system is part of a respirator or mask configured to deliver a therapeutically effect amount of the treatment gas to at least a portion of the respiratory tract of the subject. In some examples, the method comprises treating ambient air within a chamber having a volume by releasing the treatment gas generated by the media into the chamber, and the subject is located within the chamber, such that the subject inhales the treated ambient air within the chamber. In some examples, the treatment gas delivered to the subject has a concentration of 1 ppmv or less. In some examples, the disease or disorder comprises an infection. In some examples, the disease or disorder comprises a respiratory infection. In some examples, the disease or disorder comprises an infection with a coronavirus, influenza virus, or a combination thereof.

Also disclosed herein are articles of manufacture comprising any of the filter systems disclosed herein, wherein the article of manufacture can, for example, comprise a respirator, a gas mask, a personal protection device, or a combination thereof. In some examples, the respirator, gas mask, or personal protection device provides protection from exposure to harmful chemical and/or biological agents. In some examples, the respirator, the gas mask, or the personal protection device is suitable for use by a subject in need of protection, wherein the subject is a human, a service animal, a law-enforcement animal, a cadaver animal, a search-and-rescue animal, a military animal, or a detection animal.

Additional advantages of the disclosed systems and methods will be set forth in part in the description which follows, and in part will be obvious from the description. The advantages of the disclosed systems and methods will be realized and attained by means of the elements and combinations particularly pointed out in the appended claims. It is to be understood that both the foregoing general description and the following detailed description are exemplary and explanatory only and are not restrictive of the disclosed systems and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1 is a photograph of an example filter system as disclosed herein.

FIG. 2 is a photograph of an example filter system as disclosed herein disposed within a chamber.

### DETAILED DESCRIPTION

The systems and methods described herein may be understood more readily by reference to the following detailed description of specific aspects of the disclosed subject matter and the examples included therein.

### Definitions

Throughout the description and claims of this specification the word “comprise” and other forms of the word, such as “comprising” and “comprises,” means “including but not limited to,” and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Exemplary” means “an example of” and is not intended to convey an indication of a preferred or ideal embodiment. “Such as” is not used in a restrictive sense, but for explanatory purposes.

Values can be expressed herein as an “average” value. “Average” generally refers to the statistical mean value.

By “substantially” is meant within 5%, e.g., within 4%, 3%, 2%, or 1%.

It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, by a “subject” is meant an individual. Thus, the “subject” can include domesticated animals (e.g., cats, dogs, etc.), livestock (e.g., cattle, horses, pigs, sheep, goats, etc.), laboratory animals (e.g., mouse, rabbit, rat, guinea pig, etc.), and birds. “Subject” can also include a mammal, such as a primate or a human. Thus, the subject can be a human or veterinary patient. The term “patient” refers to a subject under the treatment of a clinician, e.g., physician.

As used herein, antimicrobials include, for example, antibacterials, antifungals, and antivirals. As used herein, “antimicrobial” refers to the ability to treat or control (e.g., reduce, prevent, treat, or eliminate) the growth of a microbe at any concentration. Similarly, the terms “antibacterial,” “antifungal,” and “antiviral” refer to the ability to treat or control the growth of bacteria, fungi, and viruses at any concentration, respectively.

The term “inhibit” refers to a decrease in an activity, response, condition, disease, or other biological parameter. This can include but is not limited to the complete ablation of the activity, response, condition, or disease. This can also include, for example, a 10% reduction in the activity, response, condition, or disease as compared to the native or control level. Thus, the reduction can be a 10, 20, 30, 40, 50, 60, 70, 80, 90, 100%, or any amount of reduction in between as compared to native or control levels.

As used herein, “reduce” or other forms of the word, such as “reducing” or “reduction,” refers to lowering of an event or characteristic (e.g., microbe population/infection). It is understood that the reduction is typically in relation to some standard or expected value. For example, “reducing microbial infection” means reducing the spread of a microbial infection relative to a standard or a control.

As used herein, “prevent” or other forms of the word, such as “preventing” or “prevention,” refers to stopping a particular event or characteristic, stabilizing or delaying the development or progression of a particular event or characteristic, or minimizing the chances that a particular event or characteristic will occur. “Prevent” does not require comparison to a control as it is typically more absolute than, for example, “reduce.” As used herein, something could be reduced but not prevented, but something that is reduced could also be prevented. Likewise, something could be prevented but not reduced, but something that is prevented could also be reduced. For example, the terms “prevent” or “suppress” can refer to a treatment that forestalls or slows the onset of a disease or condition or reduced the severity of the disease or condition. Thus, if a treatment can treat a disease in a subject having symptoms of the disease, it can also prevent or suppress that disease in a subject who has yet to suffer some or all of the symptoms.

As used herein, “treat” or other forms of the word, such as “treated” or “treatment,” refers to administration of a composition or performing a method in order to reduce, prevent, inhibit, or eliminate a particular characteristic or event (e.g., microbe growth or survival). The term “control” is used synonymously with the term “treat.”

The term “therapeutically effective amount” refers to the amount of the composition used is of sufficient quantity to ameliorate one or more causes or symptoms of a disease or disorder. Such amelioration only requires a reduction or alteration, not necessarily elimination.

The term “pharmaceutically acceptable” refers to those compounds, materials, compositions, and/or dosage forms which are, within the scope of sound medical judgment, suitable for use in contact with the tissues of human beings and animals without excessive toxicity, irritation, allergic response, or other problems or complications commensurate with a reasonable benefit/risk ratio.

As used herein, the term “delivery” encompasses both local and systemic delivery.

### Systems and Methods

Disclosed herein are systems and methods for treating air.

For example, disclosed herein is a filter system for treating air, the filter system comprising: a first filter comprising a media; wherein air directed to flow through the filter system contacts the first filter; wherein the media is configured to generate a treatment gas from a precursor, such that the treatment gas is released into the flow path of the air; and wherein the treatment gas comprises chlorine dioxide (ClO₂) and the precursor comprises a chlorine dioxide precursor, the treatment gas comprises carbon dioxide (CO₂) and the precursor comprises a carbon dioxide precursor, or a combination thereof. Although the systems and methods herein are described as using air, the systems and methods can encompass the use of other components (e.g., nitrogen). For example, the air can comprise an acidic gas compound such as hydrogen cyanide, hydrogen sulfide, hydrochloric acid, hydrogen fluoride, hydrogen iodide, hydrogen bromide, nitric acid vapor, chlorine, carbon disulfide, mercaptans, or a combination thereof.

In some examples, the filter system can comprise a second filter (e.g., one or more second filters) sequentially arranged relative to the first filter along the direction of air flow. The second filter can comprise any type of air filter, such as those known in the art. For example, the second filter can comprise a filter for removal of particulates from the air, such as a coarse filter (e.g., a filter for removal of coarse particles, such as those in glass G1-G4), a fine filter (e.g., class M5, M6, F7, F8, F9), a semi-HEPA filter (e.g., class E10, E11, E12), a HEPA filter (e.g., class H13, H14), a ULPA filter (e.g., class U15, U16, U17), or a combination thereof. In some examples, the second filter can comprise an activated carbon filter.

The precursor can be provided in any form that allows the precursor to react with protons (e.g., from a proton-generating species) to produce the treatment gas. In some examples, the media comprises the precursor and the precursor reacts with protons in the air or in the media. In some examples, the media comprises an electrostatically charged surface.

In some examples, the media comprises dry particles comprising the precursor. As used herein, the term “dry particles” indicates the particles have a water content of 20% or less (e.g., 15% or less, 10% or less, 5% or less, 4% or less, 3% or less, 2% or less, or 1% or less) by weight.

In some examples, the dry particles comprising the precursor are in the form of a powder. In some examples, the dry particles comprising the precursor can include a porous carrier wherein the precursor is impregnated in the porous carrier. In some examples, the porous carrier is inert. In some examples, the porous carrier has pores, channels, or the like located therein. Exemplary porous carriers include, but are not limited to, silica, pumice, diatomaceous earth, bentonite, clay, porous polymer, alumina, zeolite (e.g., zeolite crystals), or mixtures thereof. In some embodiments, the porous carrier is uniformly impregnated throughout the volume of the porous carrier via the pores, channels, and the like, with the precursor.

The porous carrier can have an average particle size. “Average particle size” and “mean particle size” are used interchangeably herein, and generally refer to the statistical mean particle size of the particles in a population of particles. For example, the average particle size for a plurality of particles with a substantially spherical shape can comprise the average diameter of the plurality of particles. For an anisotropic particle, the average particle size can refer to, for example, the average maximum dimension of the particle (e.g., the length of a rod shaped particle, the diagonal of a cube shaped particle, the bisector of a triangular shaped particle, etc.) Mean particle size can be measured using methods known in the art, such as sieving or microscopy.

In some examples, the porous carrier can have an average particle size, in its largest dimension, of 0.5 micrometers (microns, μm) or more (e.g., 1 μm or more, 2 μm or more, 3 μm or more, 4 μm or more, 5 μm or more, 10 μm or more, 15 μm or more, 20 μm or more, 25 μm or more, 30 μm or more, 35 μm or more, 40 μm or more, 50 μm or more, 60 μm or more, 70 μm or more, 80 μm or more, 90 μm or more, 100 μm or more, 125 μm or more, 150 μm or more, 175 μm or more, 200 μm or more, 225 μm or more, 250 μm or more, 300 μm or more, 350 μm or more, 400 μm or more, 450 μm or more, 500 μm or more, 600 μm or more, 700 μm or more, 800 μm or more, 900 μm or more, 1 millimeters (mm) or more, 2 mm or more, 3 mm or more, 4 mm or more, 5 mm or more, 6 mm or more, 7 mm or more, 8 mm or more, 9 mm or more, 10 mm or more, 15 mm or more, or 20 mm or more). In some examples, the porous carrier can have an average particle size of 25.4 mm (e.g., 1 inch) or less (e.g., 24 mm or less, 23 mm or less, 22 mm or less, 21 mm or less, 20 mm or less, 19 mm or less, 18 mm or less, 17 mm or less, 16 mm or less, 15 mm or less, 14 mm or less, 13 mm or less, 12 mm or less, 11 mm or less, 10 mm or less, 9 mm or less, 8 mm or less, 7 mm or less, 6 mm or less, 5 mm or less, 4 mm or less, 3 mm or less, 2 mm or less, 1 mm or less, 900 μm or less, 800 μm or less, 700 μm or less, 600 μm or less, 500 μm or less, 450 μm or less, 400 μm or less, 350 μm or less, 300 μm or less, 250 μm or less, 225 μm or less, 200 μm or less, 175 μm or less, 150 μm or less, 125 μm or less, 100 μm or less, 90 μm or less, 80 μm or less, 70 μm or less, 60 μm or less, 50 μm or less, 40 μm or less, 35 μm or less, 30 μm or less, 25 μm or less, 20 μm or less, 15 μm or less, 10 μm or less, or 5 μm or less). The average particle size of the porous carrier in their largest dimension can range from any of the minimum values described above to any of the maximum values described above. For example, the porous carrier can have an average particle size of from 0.5 μm to 25.4 mm (e.g., 0.5 μm to 1 mm, from 1 mm to 25.4 mm, from 0.5 μm to 100 μm, from 100 μm to 500 μm, from 500 μm to 1 mm, from 1 mm to 10 mm, from 10 mm to 25.4 mm, from 175 μm to 400 μm, or from 600 μm to 2 mm).

In some examples, the dry particles comprising the precursor include 1% or more by weight of the precursor (e.g., 2% or more, 3% or more, 4% or more, 5% or more, 6% or more, 7% or more, 8% or more, 9% or more, 10% or more, 15% or more, 20% or more, 25% or more, 30% or more, 35% or more, 40% or more, 45% or more, 50% or more, 60% or more, 70% or more, 80% or more, 90% or more, or 95% or more). In some examples, the dry particle comprising the precursor includes 100% or less by weight of the precursor (e.g., 95% or less, 90% or less, 85% or less, 80% or less, 75% or less, 70% or less, 65% or less, 60% or less, 55% or less, 50% or less, 40% or less, 30% or less, 20% or less, 15% or less, 10% or less, or 5% or less). In some embodiments, the dry particles comprising the precursor includes a porous carrier impregnated with a precursor and the porous carrier includes 1% or more by weight of the precursor (such as in the amounts provided above) and/or 50% or less by weight of the precursor (e.g., 40% or less, 30% or less, 20% or less, or 10% or less). The amount of precursor in the dry particles comprising the precursor can range from any of the minimum values described above to any of the maximum values described above. For example, the dry particle comprising the precursor can include from 1% to 100% by weight of the precursor (e.g., from 1% to 50%, from 50% to 100%, from 1% to 25%, from 25% to 50%, from 50% to 75%, from 75% to 100%, from 1% to 90%, or from 1% to 50%).

In some examples, the porous carrier is impregnated with the precursor by using a porous carrier that has a low moisture (e.g., water) content. In some examples, the low moisture content is 20% or less (e.g., 15% or less, 10% or less, 5% or less, 4% or less, 3% or less, 2% or less, or 1% or less) by weight. In some examples, the porous carrier has an initial moisture content above 5% and thus can be dehydrated to produce a moisture content of 5% or less. In some examples, the dehydrated porous carrier is then immersed in or sprayed with an aqueous solution of the precursor at an elevated temperature (e.g., in the range from 120° F. to 190° F.) and the resulting slurry is thoroughly mixed. In some examples, the mixed slurry is then air-dried to a moisture level of 20% or less (e.g., 15% or less, 10% or less, 5% or less, 4% or less, 3% or less, 2% or less, or 1% or less) by weight to produce the impregnate (i.e., precursor impregnated in a porous carrier) disclosed herein. In some examples, the impregnate disclosed herein can be prepared without a drying step by calculating the amount of the aqueous solution of the precursor needed to achieve the desired final moisture level (e.g., 20% or less, 15% or less, 10% or less, 5% or less, 4% or less, 3% or less, 2% or less, or 1% or less) and adding this amount of the aqueous solution to the dehydrated porous carrier to impregnate the porous carrier, thereby forming the dry particles comprising the precursor.

In some examples, the precursor is impregnated into a porous carrier and treated with a base. In some examples, the base is any suitable base that can reduce the available protons and inhibit the reaction until the proton-generating species overcomes the base and reacts with the precursor, to enhance shelf stability and slow the reaction rate once the mixture is activated. Exemplary bases include, but are not limited to, potassium hydroxide, sodium hydroxide, calcium hydroxide, or a blend thereof. In some examples, the amount of base can be selected in view of a variety of factors, such as such as the desired amount of treatment gas produces and/or the desired rate at which the treatment gas is produced.

In some embodiments, the precursor can, for example, comprise a chlorine dioxide precursor and the treatment gas can comprise chlorine dioxide; the precursor can comprise a carbon dioxide precursor and the treatment gas can comprise carbon dioxide; or a combination thereof.

The chlorine dioxide precursor can be selected from any composition capable of producing chlorine dioxide gas. The chlorine dioxide precursor can, for example, comprise a chlorine dioxide-producing compound selected from the group consisting of a metal chlorite, a metal chlorate, chloric acid, hypochlorous acid, and combinations thereof. Examples of metal chlorites include, but are not limited to, sodium chlorite, barium chlorite, calcium chlorite, lithium chlorite, potassium chlorite, magnesium chlorite, and combinations thereof. Examples of metal chlorates include, but are not limited to, sodium chlorate, lithium chlorate, potassium chlorate, magnesium chlorate, barium chlorate, and combinations thereof. In some examples, the chlorine dioxide precursor is impregnated in a porous carrier such as zeolite crystals as described above and as described in U.S. Pat. Nos. 5,567,405; 5,573,743; 5,730,948; 5,776,850; 5,853,689; 5,885,543; 6,174,508; 6,379,643; 6,423,289; 7,347,994; 7,922,992; and 9,382,116, which are incorporated by reference in their entirety.

The carbon dioxide precursor can be selected from any composition capable of producing carbon dioxide gas. The carbon dioxide precursor can, for example, comprise a carbon-containing compound selected from the group consisting of carbonates, bicarbonates, sesquicarbonates, and combinations thereof. Examples of carbon-containing compounds include, but are not limited to, sodium carbonate, sodium bicarbonate, sodium sesquicarbonate, and combinations thereof. In some examples, the carbon dioxide precursor is impregnated in a porous carrier such as zeolite crystals as described above and as described in U.S. Pat Nos. 7,992,992 and 8,709,396, which are hereby incorporated herein by reference in their entirety.

In some examples, the media can further comprise a proton generating species. A proton-generating species as disclosed herein can be any composition capable of generating protons to react with the precursor to generate the treatment gas. The proton-generating species can, for example, comprise an organic acid, an inorganic acid, a metal salt, or a combination thereof. In some examples, the organic acid and/or an inorganic acid can be selected from the group consisting of acetic acid, citric acid, hydrochloric acid, phosphoric acid, propionic acid, sulfuric acid, and combinations thereof. Examples of metal salts include, but are not limited to, ferric chloride, ferric sulfate, CaCl₂, ZnSO₄, ZnCl₂, CoSO₄, CoCl₂, MnSO₄, MnCl₂, CuSO₄, CuCl₂, MgSO₄, sodium acetate, sodium citrate, sodium sulfate, sodium bisulfate, hydrogen phosphate, disodium hydrogen phosphate, and combinations thereof. In some examples, the proton-generating species can comprise a volatile acid. In some examples, the proton-generating species is a metal salt that can also act as a water-retaining substance (e.g., CaCl₂, MgSO₄). In some examples, the proton-generating species can be part of the porous carrier.

In some examples, the proton-generating species is activated to produce protons by contacting the proton-generating species with a moisture-containing (or water-containing) fluid. In some embodiments, the metal salt is ferric chloride, ferric sulfate, or a mixture thereof, and these iron salts can absorb water in addition to functioning as a proton-generating species. In some embodiments, the moisture-containing fluid is liquid water or an aqueous solution. In some embodiments, the moisture-containing fluid is a moisture-containing gas such as air or water vapor. In some embodiments, the protons produced by the proton-generating species react with the precursor to the treatment gas. The proton-generating species can also be activated other than by exposure to a moisture-containing fluid. In some embodiments, the proton-generating species can be activated and can release protons upon exposure to the water in the powders or impregnated porous carrier containing the precursor.

The proton-generating species can be provided in any form that allows the release of protons.

In some examples, the media further comprises dry particles comprising the proton-generating species. As used herein, the term “dry particles” indicates the particles have a water content of 20% or less (e.g., 15% or less, 10% or less, 5% or less, 4% or less, 3% or less, 2% or less, or 1% or less) by weight.

In some examples, the dry particles comprising the proton-generating species are in the form of a powder. In some examples, the dry particles comprising the proton-generating species can include a porous carrier wherein the proton-generating species is impregnated in the porous carrier. In some examples, the porous carrier is inert. In some examples, the porous carrier has pores, channels, or the like located therein. Exemplary porous carriers include, but are not limited to, silica, pumice, diatomaceous earth, bentonite, clay, porous polymer, alumina, zeolite (e.g., zeolite crystals), or mixtures thereof. In some embodiments, the porous carrier is uniformly impregnated throughout the volume of the porous carrier via the pores, channels, and the like, with the proton-generating species. In some examples, the porous carrier can have an average particle size, in their largest dimension, of 0.5 micrometers (microns, μm) or more (e.g., 1 μm or more, 2 μm or more, 3 μm or more, 4 μm or more, 5 μm or more, 10 μm or more, 15 μm or more, 20 μm or more, 25 μm or more, 30 μm or more, 35 μm or more, 40 μm or more, 50 μm or more, 60 μm or more, 70 μm or more, 80 μm or more, 90 μm or more, 100 μm or more, 125 μm or more, 150 μm or more, 175 μm or more, 200 μm or more, 225 μm or more, 250 μm or more, 300 μm or more, 350 μm or more, 400 μm or more, 450 μm or more, 500 μm or more, 600 μm or more, 700 μm or more, 800 μm or more, 900 μm or more, 1 millimeters (mm) or more, 2 mm or more, 3 mm or more, 4 mm or more, 5 mm or more, 6 mm or more, 7 mm or more, 8 mm or more, 9 mm or more, 10 mm or more, 15 mm or more, or 20 mm or more). In some examples, the porous carrier can have an average particle size of 25.4 mm (e.g., 1 inch) or less (e.g., 24 mm or less, 23 mm or less, 22 mm or less, 21 mm or less, 20 mm or less, 19 mm or less, 18 mm or less, 17 mm or less, 16 mm or less, 15 mm or less, 14 mm or less, 13 mm or less, 12 mm or less, 11 mm or less, 10 mm or less, 9 mm or less, 8 mm or less, 7 mm or less, 6 mm or less, 5 mm or less, 4 mm or less, 3 mm or less, 2 mm or less, 1 mm or less, 900 μm or less, 800 μm or less, 700 μm or less, 600 μm or less, 500 μm or less, 450 μm or less, 400 μm or less, 350 μm or less, 300 μm or less, 250 μm or less, 225 μm or less, 200 μm or less, 175 μm or less, 150 μm or less, 125 μm or less, 100 μm or less, 90 μm or less, 80 μm or less, 70 μm or less, 60 μm or less, 50 μm or less, 40 μm or less, 35 μm or less, 30 μm or less, 25 μm or less, 20 μm or less, 15 μm or less, 10 μm or less, or 5 μm or less), in their largest dimension. The average particle size of the porous carrier in their largest dimension can range from any of the minimum values described above to any of the maximum values described above. For example, the porous carrier can have an average particle size of from 0.5 μm to 25.4 mm (e.g., 0.5 μm to 1 mm, from 1 mm to 25.4 mm, from 0.5 μm to 100 μm, from 100 μm to 500 μm, from 500 μm to 1 mm, from 1 mm to 10 mm, from 10 mm to 25.4 mm, from 175 μm to 400 μm, or from 600 μm to 2 mm).

In some examples, the dry particles comprising the proton-generating species include 1% or more by weight of the proton-generating species (e.g., 2% or more, 3% or more, 4% or more, 5% or more, 6% or more, 7% or more, 8% or more, 9% or more, 10% or more, 15% or more, 20% or more, 25% or more, 30% or more, 35% or more, 40% or more, 45% or more, 50% or more, 60% or more, 70% or more, 80% or more, 90% or more, or 95% or more). In some examples, the dry particle comprising the proton-generating species includes 100% or less by weight of the proton-generating species (e.g., 95% or less, 90% or less, 85% or less, 80% or less, 75% or less, 70% or less, 65% or less, 60% or less, 55% or less, 50% or less, 40% or less, 30% or less, 20% or less, 15% or less, 10% or less, or 5% or less). In some embodiments, the dry particles comprising the proton-generating species includes a porous carrier impregnated with a proton-generating species and the porous carrier includes 1% or more by weight of the proton-generating species (such as in the amounts provided above) and/or 50% or less by weight of the proton-generating species (e.g., 40% or less, 30% or less, 20% or less, or 10% or less). The amount of proton-generating species in the dry particles comprising the proton-generating species can range from any of the minimum values described above to any of the maximum values described above. For example, the dry particles comprising the proton-generating species can include from 1% to 100% by weight of the proton-generating species (e.g., from 1% to 50%, from 50% to 100%, from 1% to 25%, from 25% to 50%, from 50% to 75%, from 75% to 100%, from 1% to 90%, or from 1% to 50%).

In some examples, the porous carrier is impregnated with the proton-generating species by using a porous carrier that has a low moisture (e.g., water) content. In some embodiments, the low moisture content is 20% or less (e.g., 15% or less, 10% or less, 5% or less, 4% or less, 3% or less, 2% or less, or 1% or less) by weight. In some embodiments, the porous carrier has an initial moisture content above 5% and thus can be dehydrated to produce a moisture content of 5% or less. In some embodiments, the dehydrated porous carrier is then immersed in or sprayed with an aqueous solution of the proton-generating species at an elevated temperature (e.g., in the range from 120° F. to 190° F.) and the resulting slurry is thoroughly mixed. In some embodiments, the mixed slurry is then air-dried to a moisture level of from 0% to 20% (e.g., 20% or less, 15% or less, 10% or less, 5% or less, 4% or less, 3% or less, 2% or less, or 1% or less) by weight to produce an impregnate (i.e., proton-generating species impregnated in a porous carrier). In some embodiments, the impregnate disclosed herein can be prepared without a drying step by calculating the amount of the aqueous solution of the proton-generating species needed to achieve the desired final moisture level (e.g., 20% or less, 15% or less, 10% or less, 5% or less, 4% or less, 3% or less, 2% or less, or 1% or less) and adding this amount of the aqueous solution to the dehydrated porous carrier to impregnate the porous carrier, thereby forming the dry particles comprising the proton-generating species.

In some examples, the media can further comprise a deliquescent. Examples of deliquescents include, but are not limited to, aluminum chloride, aluminum nitrate, ammonium bifluoride, cadmium nitrate, cesium hydroxide, calcium chloride, calcium iodide, cobalt(II) chloride, gold(III) chloride, iron(III) chloride, iron(III) nitrate, lithium iodide, lithium nitrate, magnesium chloride, magnesium iodide, manganese(II) sulfate, mesoxalic acid, potassium carbonate, potassium oxide, silver perchlorate, sodium formate, sodium nitrate, tachyhydrite, taurocholic acid, tellurium tetrachloride, tin(II) chloride, tin(II) sulfate, yttrium(III) chloride, zinc chloride, and combinations thereof. In some examples, the deliquescent is in the form of a powder. In some examples, the deliquescent can be impregnated in a porous carrier. In some examples, the porous carrier is inert. In some examples, the porous carrier has pores, channels, or the like located therein. In some examples, the porous carrier is uniformly impregnated throughout the volume of the porous carrier via the pores, channels, and the like, with the deliquescent. In some examples, the porous carrier impregnated with the deliquescent is separate from the porous carrier impregnated with the precursor and/or the porous carrier impregnated with the proton-generating species.

In some examples, the media can further comprise a desiccant. Examples of desiccants include, but are not limited to, activated alumina, benzophenone, bentonite clay, calcium oxide, calcium sulfate (Drierite), calcium sulfonate, copper(II) sulfate, lithium chloride, lithium bromide, magnesium sulfate, magnesium perchlorate, molecular sieves, potassium carbonate, potassium hydroxide, silica gel, sodium, sodium chlorate, sodium chloride, sodium hydroxide, sodium sulfate, sucrose, and combinations thereof. In some examples, the desiccant is in the form of a powder. In some examples, the desiccant can be impregnated in a porous carrier. In some examples, the porous carrier is inert. In some examples, the porous carrier has pores, channels, or the like located therein. In some examples, the porous carrier is uniformly impregnated throughout the volume of the porous carrier via the pores, channels, and the like, with the desiccant. In some examples, the porous carrier impregnated with the desiccant is separate from the porous carrier impregnated with the precursor and/or the porous carrier impregnated with the proton-generating species.

In some examples, the media can be disposed within the first filter with an average total thickness of 1 centimeter (cm) or more (e.g., 1.5 cm or more, 2 cm or more, 2.5 cm or more, 3 cm or more, 3.5 cm or more, 4 cm or more, 4.5 cm or more, 5 cm or more, 6 cm or more, 7 cm or more, 8 cm or more, 9 cm or more, 10 cm or more, 15 cm or more, 20 cm or more, 25 cm or more, 30 cm or more, 35 cm or more, or 40 cm or more). In some examples, the average total thickness of the media in the first filter can be 50 cm or less (e.g., 45 cm or less, 40 cm or less, 35 cm or less, 30 cm or less, 25 cm or less, 20 cm or less, 15 cm or less, 10 cm or less, 9 cm or less, 8 cm or less, 7 cm or less, 6 cm or less, 5 cm or less, 4.5 cm or less, 4 cm or less, 3.5 cm or less, 3 cm or less, or 2.5 cm or less). The average total thickness of the media in the first filter can range from any of the minimum values described above to any of the maximum values described above. For example, the average total thickness of the media in the first filter can be from 1 cm to 50 cm (e.g., from 1 cm to 25 cm, from 25 cm to 50 cm, from 1 cm to 40 cm, from 1 cm to 30 cm, from 1 cm to 20 cm, or from 2.5 cm to 10 cm).

In some examples, the media comprises dry particles comprising the precursor and dry particles comprising the proton generating species.

In some examples, the media is disposed within the first filter as a mixture of the dry particles of comprising the precursor and the dry particles comprising the proton generating species.

In some examples, the media is disposed within the first filter as a layered bed comprising two or more alternating layers of the dry particles comprising the precursor and the dry particles comprising the proton-generating species. In some examples, the first layer in the bed contacted with the air is a layer of dry particles comprising the proton-generating species. In some examples, the layered bed comprises the alternating layers and further comprises at least one layer comprising a mixture of dry particles comprising the precursor and dry particles comprising the proton-generating species.

In some examples, the total number of layers in the layered bed is from 3 layers or more (e.g., 4 layers or more, 5 layers or more, 6 layers or more, 7 layers or more, 8 layers or more, 9 layers or more, 10 layers or more, 11 layers or more, 12 layers or more, 13 layers or more, 14 layers or more, 15 layers or more, 16 layers or more, 17 layers or more, 18 layers or more, 19 layers or more, 20 layers or more, 22 layers or more, 24 layers or more, 26 layers or more, 28 layers or more, 30 layers or more, 35 layers or more, or 40 layers or more). In some examples, the total number of layers in the layered bed is 48 layers or less (e.g., 46 layers or less, 44 layers or less, 42 layers or less, 40 layers or less, 38 layers or less, 36 layers or less, 34 layers or less, 32 layers or less, 30 layers or less, 28 layers or less, 26 layers or less, 24 layers or less, 22 layers or less, 20 layers or less, 19 layers or less, 18 layers or less, 17 layers or less, 16 layers or less, 15 layers or less, 14 layers or less, 13 layers or less, 12 layers or less, 11 layers or less, 10 layers or less, 9 layers or less, 8 layers or less, 7 layers or less, 6 layers or less, or S layers or less). The total number of layered in the layered bed can range from any of the minimum values described above to any of the maximum values described above. For example, the total number of layers in the layered bed can be from 3 layers to 48 layers (e.g., from 3 layers to 24 layers, from 24 layers to 48 layers, from 3 layers to 30 layers, from 3 layers to 20 layers, or from 4 layers to 16 layers).

In some examples, the bed can further include a porous woven or nonwoven layer before, after, and/or between one or more of the layers to separate the layers. The woven or nonwoven layer can be formed of a polymer material such as polyethylene, polypropylene or polyester (e.g., polyethylene terephthalate (PET)). For example, the porous separator layer can be a spun bond nonwoven polyester layer.

Each layer of the layered bed can have an average thickness, wherein the thickness of a layer is the dimension of the layer that the air traverses during fluid flow. For example, the average thickness of each of the layers of dry particles comprising the precursor in the layered bed can be 1 centimeter (cm) or more (e.g., 1.5 cm or more, 2 cm or more, 2.5 cm or more, 3 cm or more, 3.5 cm or more, 4 cm or more, 4.5 cm or more, 5 cm or more, 6 cm or more, 7 cm or more, 8 cm or more, 9 cm or more, 10 cm or more, 15 cm or more, 20 cm or more, 25 cm or more, 30 cm or more, 35 cm or more, or 40 cm or more). In some examples, the average thickness of each of the layers of dry particles comprising the precursor in the layered bed can be 50 cm or less (e.g., 45 cm or less, 40 cm or less, 35 cm or less, 30 cm or less, 25 cm or less, 20 cm or less, 15 cm or less, 10 cm or less, 9 cm or less, 8 cm or less, 7 cm or less, 6 cm or less, 5 cm or less, 4.5 cm or less, 4 cm or less, 3.5 cm or less, 3 cm or less, or 2.5 cm or less). The average thickness of each of the layers of dry particles comprising the precursor in the layered bed can range from any of the minimum values described above to any of the maximum values described above. For example, the average thickness of each of the layers of dry particles comprising the precursor in the layered bed can be from 1 cm to 50 cm (e.g., from 1 cm to 25 cm, from 25 cm to 50 cm, from 1 cm to 40 cm, from 1 cm to 30 cm, from 1 cm to 20 cm, or from 2.5 cm to 10 cm).

The average thickness of each of the layers of dry particles comprising the proton-generating species in the layered bed can be 1 centimeter (cm) or more (e.g., 1.5 cm or more, 2 cm or more, 2.5 cm or more, 3 cm or more, 3.5 cm or more, 4 cm or more, 4.5 cm or more, 5 cm or more, 6 cm or more, 7 cm or more, 8 cm or more, 9 cm or more, 10 cm or more, 15 cm or more, 20 cm or more, 25 cm or more, 30 cm or more, 35 cm or more, or 40 cm or more). In some examples, the average thickness of each of the layers of dry particles comprising the proton-generating species in the layered bed can be 50 cm or less (e.g., 45 cm or less, 40 cm or less, 35 cm or less, 30 cm or less, 25 cm or less, 20 cm or less, 15 cm or less, 10 cm or less, 9 cm or less, 8 cm or less, 7 cm or less, 6 cm or less, 5 cm or less, 4.5 cm or less, 4 cm or less, 3.5 cm or less, 3 cm or less, or 2.5 cm or less). The average thickness of each of the layers of dry particles comprising the proton-generating species in the layered bed can range from any of the minimum values described above to any of the maximum values described above. For example, the average thickness of each of the layers of dry particles comprising the proton-generating species in the layered bed can be from 1 cm to 50 cm (e.g., from 1 cm to 25 cm, from 25 cm to 50 cm, from 1 cm to 40 cm, from 1 cm to 30 cm, from 1 cm to 20 cm, or from 2.5 cm to 10 cm).

In some examples, the average thickness of each of the layers of dry particles comprising the precursor in the layered bed can be substantially the same as the average thickness of each of the layers of dry particles comprising the proton-generating species in the layered bed. For example, the average thickness of each of the layers in the layered bed can be 1 centimeter (cm) or more (e.g., 1.5 cm or more, 2 cm or more, 2.5 cm or more, 3 cm or more, 3.5 cm or more, 4 cm or more, 4.5 cm or more, 5 cm or more, 6 cm or more, 7 cm or more, 8 cm or more, 9 cm or more, 10 cm or more, 15 cm or more, 20 cm or more, 25 cm or more, 30 cm or more, 35 cm or more, or 40 cm or more). In some examples, the average thickness of each of the layers in the layered bed can be 50 cm or less (e.g., 45 cm or less, 40 cm or less, 35 cm or less, 30 cm or less, 25 cm or less, 20 cm or less, 15 cm or less, 10 cm or less, 9 cm or less, 8 cm or less, 7 cm or less, 6 cm or less, 5 cm or less, 4.5 cm or less, 4 cm or less, 3.5 cm or less, 3 cm or less, or 2.5 cm or less). The average thickness of each of the layers in the layered bed can range from any of the minimum values described above to any of the maximum values described above. For example, the average thickness of each of the layers in the layered bed can be from 1 cm to 50 cm (e.g., from 1 cm to 25 cm, from 25 cm to 50 cm, from 1 cm to 40 cm, from 1 cm to 30 cm, from 1 cm to 20 cm, or from 2.5 cm to 10 cm).

The media is generally stable and can be assembled into the first filter prior to use in an application. The first filter can be stored and shipped separately at humidity and/or air flow conditions designed to maintain stability.

For example, the dry particles comprising the precursor and the dry particles comprising the proton-generating species are generally stable and can be assembled into a layered bed and/or the first filter prior to use in an application. The dry particles comprising the precursor and the dry particles comprising the proton-generating species can be stored and shipped separately at minimal humidity. For example, the dry particles comprising the precursor and the dry particles comprising the proton-generating species can each be provided in separate sealed drums. The drums can be opened and the layered bed and/or the first filter can be prepared just prior to use. In some examples, such as those exemplified in U.S. Pat. No. 9,382,116, the layered bed can be prepared prior to shipment. Methods of maintaining the stability of the layered bed in storage are described in U.S. Pat. No. 9,382,116, which is incorporated by reference herein in its entirety.

In some examples, the first filter can further comprise a support structure. The support structure can, for example, comprise a rigid material such as a polymer (e.g., polyethylene), a metal (e.g., aluminum, galvanized steel, titanium, tantalum), or combinations thereof.

The support structure can help hold the media within the first filter and/or give the first filter a desired rigidity. The support structure can, for example, comprise a frame defining the perimeter of the first filter. The frame can have any shape (e.g., rectangular, square, round, etc.). In some examples, the support structure can comprise a grid structure (e.g., square grid, honeycomb grid, etc.) disposed throughout the first filter. In some examples, the support structure comprises a grid structure comprising a plurality of wells, and the media is disposed within the plurality of wells.

The frame can comprise any suitable material. In some examples, the frame can be compatible with the treatment gas, such as an oxidizing gas. For example, the frame can be substantially resistant to oxidation (e.g., by the treatment gas). The frame can, for example, be formed of a metal (e.g., aluminum, galvanized steel, titanium, tantalum) and/or a polymer material such as polyethylene, polypropylene, polyester (e.g., polyethylene terephthalate (PET)), cellulose (e.g., paper), or a combination thereof.

In some examples, the first filter comprises a frame defining the perimeter of the filter and further comprises a permeable layer defining a surface of the first filter, such that the frame and the permeable layer together define a volume and the media is at least partially enclosed or contained within the volume. In some examples, the first filter comprises a frame defining the perimeter of the filter and further comprises a first permeable layer defining a top surface of the first filter and a second permeable layer defining a bottom surface of the first filter, such that the frame, the first permeable layer, and the second permeable layer together define a volume and the media is enclosed within the volume.

In some examples, the permeable layer(s) can be bonded to the frame. For example, the permeable layer(s) can be bonded to the frame by any suitable method, such as adhesive bonding (e.g., via an appropriate glue or other adhesive, such as a polyurethane adhesive). In some examples, the adhesive and/or the permeable layer(s) can be compatible with the treatment gas, such as an oxidizing gas. For example, the adhesive and/or permeable layer(s) can be substantially resistant to oxidation (e.g., by the treatment gas).

The permeable layer(s) can, in some examples, be substantially impervious to water but allows gases (e.g., air, the treatment gas, etc.) to pass through.

The permeable layer can, in some examples, comprise a porous woven or nonwoven layer. The woven or nonwoven layer can be formed of a polymer material such as polyethylene, polypropylene, polyester (e.g., polyethylene terephthalate (PET)), cellulose (e.g., paper), or a combination thereof. For example, the porous separator layer can be a spun bond nonwoven polyester layer.

In some examples, the permeable layer can comprise a screen. The screen can, for example, comprise a metal (e.g., aluminum, galvanized steel, titanium, tantalum).

The permeable layer comprises a plurality of pores having an average characteristic dimension. The term “characteristic dimension,” as used herein refers to the largest straight line distance between two points in the plane of the permeable layer. “Average characteristic dimension” and “mean characteristic dimension” are used interchangeably herein, and generally refer to the statistical mean characteristic dimension of the plurality of pores in a population of pores. For example, for a cylindrical set of pores, the average characteristic dimension can refer to the average diameter.

The average characteristic dimension of the plurality of pores of the permeable layer can, for example, be selected in view of the average particle size of the dry particles comprising the precursor, the average particle size of the dry particles comprising the proton-generating species, or a combination thereof. For example, the average characteristic dimension of the plurality of pores of the permeable layer can be selected to be smaller than the average particle size of the dry particles comprising the precursor, the average particle size of the dry particles comprising the proton-generating species, or a combination thereof, for example so that the dry particles comprising the precursor and/or the dry particles comprising the proton-generating species do not leak out of the first filter.

In some examples, the permeable layer can further be configured to remove particulates from the air. For example, the first filter can further comprise a coarse filter (e.g., a filter for removal of coarse particles, such as those in glass G1-G4), a fine filter (e.g., class M5, M6, F7, F8, F9), a semi-HEPA filter (e.g., class E10, E11, E12), a HEPA filter (e.g., class H13, H14), a ULPA filter (e.g., class U15, U16, U17), or a combination thereof.

The first filter can have an average thickness, the thickness being the dimension along the direction of air flow. In some examples, the average thickness of the first filter can be 1 centimeter (cm) or more (e.g., 1.5 cm or more, 2 cm or more, 2.5 cm or more, 3 cm or more, 3.5 cm or more, 4 cm or more, 4.5 cm or more, 5 cm or more, 6 cm or more, 7 cm or more, 8 cm or more, 9 cm or more, 10 cm or more, 15 cm or more, 20 cm or more, 25 cm or more, 30 cm or more, 35 cm or more, or 40 cm or more). In some examples, the average thickness of the first filter can be 50 cm or less (e.g., 45 cm or less, 40 cm or less, 35 cm or less, 30 cm or less, 25 cm or less, 20 cm or less, 15 cm or less, 10 cm or less, 9 cm or less, 8 cm or less, 7 cm or less, 6 cm or less, 5 cm or less, 4.5 cm or less, 4 cm or less, 3.5 cm or less, 3 cm or less, or 2.5 cm or less). The average thickness of the first filter can range from any of the minimum values described above to any of the maximum values described above. For example, the average thickness of the first filter can be from 1 cm to 50 cm (e.g., from 1 cm to 25 cm, from 25 cm to 50 cm, from 1 cm to 40 cm, from 1 cm to 30 cm, from 1 cm to 20 cm, or from 2.5 cm to 10 cm).

The air is directed to flow through the filter system at a flow rate. For example, the air can be directed to flow through the filter system at a flow rate of 1 cubic foot per minute (cfm) or more (e.g., 2 cfm or more, 3 cfm or more, 4 cfm or more, 5 cfm or more, 6 cfm or more, 7 cfm or more, 8 cfm or more, 9 cfm or more, 10 cfm or more, 15 cfm or more, 20 cfm or more, 25 cfm or more, 30 cfm or more, 35 cfm or more, 40 cfm or more, 45 cfm or more, 50 cfm or more, 55 cfm or more, 60 cfm or more, 65 cfm or more, 70 cfm or more, 75 cfm or more, 80 cfm or more, 85 cfm or more, 90 cfm or more, 95 cfm or more, 100 cfm or more, 110 cfm or more, 120 cfm or more, 130 cfm or more, 140 cfm or more, 150 cfm or more, 160 cfm or more, 170 cfm or more, 180 cfm or more, 190 cfm or more, 200 cfm or more, 225 cfm or more, 250 cfm or more, 275 cfm or more, 300 cfm or more, 325 cfm or more, 350 cfm or more, 375 cfm or more, 400 cfm or more, 425 cfm or more, 450 cfm or more, 475 cfm or more, 500 cfm or more, 550 cfm or more, 600 cfm or more, 650 cfm or more, 700 cfm or more, 750 cfm or more, 800 cfm or more, 850 cfm or more, 900 cfm or more, or 950 cfm or more). In some examples, the air can be directed to flow through the filter system at a flow rate of 1,000 cubic feet per minute (cfm) or less (e.g., 950 cfm or less, 900 cfm or less, 850 cfm or less, 800 cfm or less, 750 cfm or less, 700 cfm or less, 650 cfm or less, 600 cfm or less, 550 cfm or less, 500 cfm or less, 475 cfm or less, 450 cfm or less, 425 cfm or less, 400 cfm or less, 375 cfm or less, 350 cfm or less, 325 cfm or less, 300 cfm or less, 275 cfm or less, 250 cfm or less, 225 cfm or less, 200 cfm or less, 190 cfm or less, 180 cfm or less, 170 cfm or less, 160 cfm or less, 150 cfm or less, 140 cfm or less, 130 cfm or less, 120 cfm or less, 110 cfm or less, 100 cfm or less, 95 cfm or less, 90 cfm or less, 85 cfm or less, 80 cfm or less, 75 cfm or less, 70 cfm or less, 65 cfm or less, 60 cfm or less, 55 cfm or less, 50 cfm or less, 45 cfm or less, 40 cfm or less, 35 cfm or less, 30 cfm or less, 25 cfm or less, 20 cfm or less, 15 cfm or less, 10 cfm or less, 9 cfm or less, 8 cfm or less, 7 cfm or less, 6 cfm or less, or 5 cfm or less). The flow rate at which the air is directed to flow through the filter system can range from any of the minimum values described above to any of the maximum values described above. For example, the air can be directed to flow through the filter system at a flow rate of from 1 cfm to 1,000 cfm (e.g., from 1 cfm to 500 cfm, from 500 cfm to 1000 cfm, from 1 cfm to 200 cfm, from 200 cfm to 400 cfm, from 400 cfm to 600 cfm, from 600 cfm to 800 cfm, from 800 cfm to 1000 cfm, from 10 cfm to 1000 cfm, from 1 cfm to 950 cfm, from 10 cfm to 950 cfm, from 50 cfm to 900 cfm, from 100 cfm to 750 cfm, from 200 cfm to 600 cfm, or from 250 cfm to 500 cfm). The air flow across through the filter system can be created naturally or by a fan, a pump, or any other device capable of creating a pressure differential across the filter system to cause movement of the air.

In some examples, the pressure drop across the filter system can be low or negligible. For example, the pressure drop can be 400 Pascals (Pa) or less (e.g., 375 Pa or less, 350 Pa or less, 325 Pa or less, 300 Pa or less, 275 Pa or less, 250 Pa or less, 225 Pa or less, 200 Pa or less, 175 Pa or less, 150 Pa or less, 125 Pa or less, 100 Pa or less, 90 Pa or less, 80 Pa or less, 70 Pa or less, 60 Pa or less, 50 Pa or less, 45 Pa or less, 40 Pa or less, 35 Pa or less, 30 Pa or less, 25 Pa or less, 20 Pa or less, 15 Pa or less, 10 Pa or less, 9 Pa or less, 8 Pa or less, 7 Pa or less, 6 Pa or less, 5 Pa or less, 4 Pa or less, 3 Pa or less, 2 Pa or less, or 1 Pa or less). In some examples, the pressure drop can be 0 Pa or more (e.g., 1 Pa or more, 2 Pa or more, 3 Pa or more, 4 Pa or more, 5 Pa or more, 6 Pa or more, 7 Pa or more, 8 Pa or more, 9 Pa or more, 10 Pa or more, 15 Pa or more, 20 Pa or more, 25 Pa or more, 30 Pa or more, 35 Pa or more, 40 Pa or more, 45 Pa or more, 50 Pa or more, 60 Pa or more, 70 Pa or more, 80 Pa or more, 90 Pa or more, 100 Pa or more, 125 Pa or more, 150 Pa or more, 175 Pa or more, 200 Pa or more, 225 Pa or more, 250 Pa or more, 275 Pa or more, 300 Pa or more, 325 Pa or more, 350 Pa or more, or 375 Pa or more). The pressure drop can range from any of the minimum values described above to any of the maximum values described above. For example, the pressure drop can be from 0 to 400 Pa (e.g., from 0 to 200 Pa, from 200 to 400 Pa, from 0 to 100 Pa, from 100 to 200 Pa, from 200 to 300 Pa, from 300 to 400 Pa, from 0 to 350 Pa, from 0 to 300 Pa, from 0 to 250 Pa, from 0 to 150 Pa, from 0 to 50 Pa, from 0 to 25 Pa, from 0 to 10 Pa, or from 0 to 5 Pa).

In some examples, the treatment gas is produced at a rate of 0.1 milligram (mg) of treatment gas per day per gram (g) of precursor initially present or more (e.g., 0.5 mg of gas/day/g of precursor or more, 1 mg of gas/day/g of precursor or more, 2 mg of gas/day/g of precursor or more, 3 mg of gas/day/g of precursor or more, 4 mg of gas/day/g of precursor or more, 5 mg of gas/day/g of precursor or more, 10 mg of gas/day/g of precursor or more, 15 mg of gas/day/g of precursor or more, 20 mg of gas/day/g of precursor or more, 25 mg of gas/day/g of precursor or more, 30 mg of gas/day/g of precursor or more, 35 mg of gas/day/g of precursor or more, 40 mg of gas/day/g of precursor or more, 45 mg of gas/day/g of precursor or more, 50 mg of gas/day/g of precursor or more, 60 mg of gas/day/g of precursor or more 70 mg of gas/day/g of precursor or more, 80 mg of gas/day/g of precursor or more, 90 mg of gas/day/g of precursor or more, 100 mg of gas/day/g of precursor or more, 150 mg of gas/day/g of precursor or more, 200 mg of gas/day/g of precursor or more, 250 mg of gas/day/g of precursor or more, 300 mg of gas/day/g of precursor or more, 350 mg of gas/day/g of precursor or more, 400 mg of gas/day/g of precursor or more, 450 mg of gas/day/g of precursor or more, or 500 mg of gas/day/g of precursor or more). In some examples, the treatment gas is produced at a rate of 600 mg of gas per day per g of precursor initially present or less (e.g., 550 mg of gas/day/g of precursor or less, 500 mg of gas/day/g of precursor or less, 450 mg of gas/day/g of precursor or less, 400 mg of gas/day/g of precursor or less, 350 mg of gas/day/g of precursor or less, 300 mg of gas/day/g of precursor or less, 250 mg of gas/day/g of precursor or less, 200 mg of gas/day/g of precursor or less, 150 mg of gas/day/g of precursor or less, 100 mg of gas/day/g of precursor or less, 90 mg of gas/day/g of precursor or less, 80 mg of gas/day/g of precursor or less, 70 mg of gas/day/g of precursor or less, 60 mg of gas/day/g of precursor or less, 50 mg of gas/day/g of precursor or less, 45 mg of gas/day/g of precursor or less, 40 mg of gas/day/g of precursor or less, 35 mg of gas/day/g of precursor or less, 30 mg of gas/day/g of precursor or less, 25 mg of gas/day/g of precursor or less, 20 mg of gas/day/g of precursor or less, 15 mg of gas/day/g of precursor or less, 10 mg of gas/day/g of precursor or less, 5 mg of gas/day/g of precursor or less, 4 mg of gas/day/g of precursor or less, 3 mg of gas/day/g of precursor or less, 2 mg of gas/day/g of precursor or less, or 1 mg of gas/day/g of precursor or less). The rate the treatment gas is produced can range from any of the minimum values described above to any of the maximum values described above. For example, the treatment gas can be produced at a rate of from 0.1 milligram of gas per day per gram of precursor initially present to 600 milligrams of gas per day per gram of precursor (e.g., from 0.1 mg of gas/day/g of precursor to 300 mg of gas/day/g of precursor, from 300 mg of gas/day/g of precursor to 600 mg of gas/day/g of precursor, from 0.1 mg of gas/day/g of precursor to 200 mg of gas/day/g of precursor from 200 mg of gas/day/g of precursor to 400 mg of gas/day/g of precursor from 400 mg of gas/day/g of precursor to 600 mg of gas/day/g of precursor, from 0.1 mg of gas/day/g of precursor to 500 mg of gas/day/g of precursor, from 0.1 mg of gas/day/g of precursor to 100 mg of gas/day/g of precursor, or from 0.1 mg of gas/day/g of precursor to 60 mg of gas/day/g of precursor).

In some examples, the air can have a humidity of 20% or more, wherein the humidity is non-condensing (e.g., 25% or more, 30% or more, 35% or more, 40% or more, 45% or more, 50% or more, 60% or more, 70% or more, 80% or more, or 90% or more). In some examples, the air can have a humidity of 100% or less, wherein the humidity is non-condensing (e.g., 95% or less, 90% or less, 85% or less, 80% or less, 75% or less, 70% or less, 60% or less, 50% or less, 40% or less, or 30% or less). The amount of humidity in the air flowed through the filter system can range from any of the minimum values described above to any of the maximum values described above. For example, the air can have a humidity of from 20% to 100%, wherein the humidity is non-condensing (e.g., from 20% to 60%, from 60% to 100%, from 20% to 40%, from 40% to 60%, from 60% to 80%, from 80% to 100%, or from 50% to 80%).

In some examples, the air exits the filter system and flows into a chamber having a volume. The chamber can, in some examples, be provided within a building (e.g., a room, garage, laboratory, fume hood, etc.).

In some examples, the first filter releases the treatment gas into the flow path of the air such that the concentration of the treatment gas within the volume of the chamber is 1 parts per million volume (ppmv) or less (e.g., 0.95 ppmv or less, 0.9 ppmv or less, 0.85 ppmv or less, 0.8 ppmv or less, 0.75 ppmv or less, 0.7 ppmv or less, 0.65 ppmv or less, 0.6 ppmv or less, 0.55 ppmv or less, 0.5 ppmv or less, 0.45 ppmv or less, 0.4 ppmv or less, 0.35 ppmv or less, 0.3 ppmv or less, 0.25 ppmv or less, 0.2 ppmv or less, 0.15 ppmv or less, 0.1 ppmv or less, 0.09 ppmv or less, 0.08 ppmv or less, 0.07 ppmv or less, 0.06 ppmv or less, 0.05 ppmv or less, 0.04 ppmv or less, 0.03 ppmv or less, or 0.02 ppmv or less). In some examples, the air exits the filter system and flows into a chamber having a volume and the first filter releases the treatment gas into the flow path of the air such that the concentration of the treatment gas within the volume of the chamber is 0.01 ppmv or more (e.g., 0.02 ppmv or more, 0.03 ppmv or more, 0.04 ppmv or more, 0.05 ppmv or more, 0.06 ppmv or more, 0.07 ppmv or more, 0.08 ppmv or more, 0.09 ppmv or more, 0.1 ppmv or more, 0.15 ppmv or more, 0.2 ppmv or more, 0.25 ppmv or more, 0.3 ppmv or more, 0.35 ppmv or more, 0.4 ppmv or more, 0.45 ppmv or more, 0.5 ppmv or more, 0.55 ppmv or more, 0.6 ppmv or more, 0.65 ppmv or more, 0.7 ppmv or more, 0.75 ppmv or more, 0.8 ppmv or more, 0.85 ppmv or more, 0.9 ppmv or more, or 0.95 ppmv or more). The concentration of treatment gas within the volume of the chamber can range from any of the minimum values described above to any of the maximum values described above. For example, the air exits the filter system and flows into a chamber having a volume and the first filter can release the treatment gas into the flow path of the air such that the concentration of the treatment gas within the volume of the chamber is from 0.01 ppmv to 1 ppmv (e.g., 0.01 ppmv to 0.1 ppmv, from 0.1 ppmv to 1 ppmv, from 0.01 ppmv to 0.05 ppmv, from 0.05 ppmv to 0.1 ppmv, from 0.1 ppmv to 0.5 ppmv, from 0.5 ppmv to 1 ppmv, from 0.02 ppmv to 1 ppmv, from 0.01 ppmv to 0.9 ppmv, or from 0.02 ppmv to 0.9 ppmv).

In some examples, the air flows through the filter system for an amount of time of 1 minute or more (e.g., 5 minutes or more, 10 minutes or more, 15 minutes or more, 30 minutes or more, 45 minutes or more, 1 hour or more, 2 hours or more, 3 hours or more, 4 hours or more, 6 hours or more, 8 hours or more, 10 hours or more, 12 hours or more, 16 hours or more, 20 hours or more, 1 day or more, 1.5 days or more, 2 days or more, 2.5 days or more, 3 days or more, 4 days or more, 5 days or more, 6 days or more, 7 days or more, 14 days or more, 21 days or more, 35 days or more, 42 days or more, 49 days or more, 56 days or more, 63 days or more, 70 days or more, 77 days or more, or 84 days or more). In some examples, the air flows through the filter system for an amount of time of 90 days or less (e.g., 84 days or less, 77 days or less, 70 days or less, 63 days or less, 56 days or less, 49 days or less, 42 days or less, 35 days or less, 21 days or less, 14 days or less, 7 days or less, 6 days or less, 5 days or less, 4 days or less, 3 days or less, 2.5 days or less, 2 days or less, 1.5 days or less, 1 day or less, 20 hours or less, 16 hours or less, 12 hours or less, 10 hours or less, 8 hours or less, 6 hours or less, 4 hours or less, 3 hours or less, 2 hours or less, 1 hour or less, 45 minutes or less, 30 minutes or less, 15 minutes or less, or 10 minutes or less). The time that the air flows through the filter system can range from any of the minimum values described above to any of the maximum values described above. For example, the air can flow through the filter system for an amount of time of from 1 minute to 90 days (e.g., from 1 minutes to 45 days, from 45 days to 90 days, from 1 minute to 1 hour, from 1 hour to 1 day, from 1 day to 7 days, from 7 days to 30 days, from 30 days to 60 days, from 60 days to 90 days, from 1 minute to 66 days, or from 5 minutes to 45 days).

In some examples, the air flows through the filter system for a first amount of time, after which the flow of air through the filter system ceases for a second amount of time. The second amount of time can be, for example, 1 minute or more (e.g., 5 minutes or more, 10 minutes or more, 15 minutes or more, 30 minutes or more, 45 minutes or more, 1 hour or more, 2 hours or more, 3 hours or more, 4 hours or more, 6 hours or more, 8 hours or more, 10 hours or more, 12 hours or more, 16 hours or more, 20 hours or more, 1 day or more, 1.5 days or more, 2 days or more, 2.5 days or more, 3 days or more, 4 days or more, 5 days or more, 6 days or more, 7 days or more, 14 days or more, 21 days or more, 35 days or more, 42 days or more, 49 days or more, 56 days or more, 63 days or more, 70 days or more, 77 days or more, or 84 days or more). In some examples, the second amount of time can be 90 days or less (e.g., 84 days or less, 77 days or less, 70 days or less, 63 days or less, 56 days or less, 49 days or less, 42 days or less, 35 days or less, 21 days or less, 14 days or less, 7 days or less, 6 days or less, 5 days or less, 4 days or less, 3 days or less, 2.5 days or less, 2 days or less, 1.5 days or less, 1 day or less, 20 hours or less, 16 hours or less, 12 hours or less, 10 hours or less, 8 hours or less, 6 hours or less, 4 hours or less, 3 hours or less, 2 hours or less, 1 hour or less, 45 minutes or less, 30 minutes or less, 15 minutes or less, or 10 minutes or less). The second amount of time can range from any of the minimum values described above to any of the maximum values described above. For example, the second amount of time can be from 1 minute to 90 days (e.g., from 1 minutes to 45 days, from 45 days to 90 days, from 1 minute to 1 hour, from 1 hour to 1 day, from 1 day to 7 days, from 7 days to 30 days, from 30 days to 60 days, from 60 days to 90 days, from 1 minute to 66 days, or from 5 minutes to 45 days).

In some examples, after the second amount of time, the air flows through the filter system for a third amount of time. The third amount of time can be, for example, 1 minute or more (e.g., 5 minutes or more, 10 minutes or more, 15 minutes or more, 30 minutes or more, 45 minutes or more, 1 hour or more, 2 hours or more, 3 hours or more, 4 hours or more, 6 hours or more, 8 hours or more, 10 hours or more, 12 hours or more, 16 hours or more, 20 hours or more, 1 day or more, 1.5 days or more, 2 days or more, 2.5 days or more, 3 days or more, 4 days or more, 5 days or more, 6 days or more, 7 days or more, 14 days or more, 21 days or more, 35 days or more, 42 days or more, 49 days or more, 56 days or more, 63 days or more, 70 days or more, 77 days or more, or 84 days or more). In some examples, the third amount of time can be 90 days or less (e.g., 84 days or less, 77 days or less, 70 days or less, 63 days or less, 56 days or less, 49 days or less, 42 days or less, 35 days or less, 21 days or less, 14 days or less, 7 days or less, 6 days or less, 5 days or less, 4 days or less, 3 days or less, 2.5 days or less, 2 days or less, 1.5 days or less, 1 day or less, 20 hours or less, 16 hours or less, 12 hours or less, 10 hours or less, 8 hours or less, 6 hours or less, 4 hours or less, 3 hours or less, 2 hours or less, 1 hour or less, 45 minutes or less, 30 minutes or less, 15 minutes or less, or 10 minutes or less). The third amount of time can range from any of the minimum values described above to any of the maximum values described above. For example, the third amount of time can be from 1 minute to 90 days (e.g., from 1 minute to 45 days, from 45 days to 66 days, from 1 minute to 1 hour, from 1 hour to 1 day, from 1 day to 7 days, from 7 days to 30 days, from 30 days to 60 days, from 60 days to 90 days, from 1 minute to 66 days, or from 5 minutes to 45 days).

In some examples, likewise, after the third amount of time, the flow of air through the filter system ceases for a fourth amount of time, and after the fourth amount of time, the air flows through the filter system for a fifth amount of time. The flow of air through the filter system can be thus pulsed for any desired number of times, with the amount of time that the air flows through the filter system and the amount of time that the air ceases to flow through the filter system can independently be selected in view of a variety of factors, such as the desired amount of treatment gas produces and/or the desired rate at which the treatment gas is produced.

In some examples, the temperature of the air can be −25° C. or more (e.g., −20° C. or more, −19° C. or more, −18° C. or more, −17° C. or more, −16° C. or more, −15° C. or more, −10° C. or more, −5° C. or more, 0° C. or more, 5° C. or more, 10° C. or more, 15° C. or more, 20° C. or more, 25° C. or more, 30° C. or more, 31° C. or more, 32° C. or more, 33° C. or more, 34° C. or more, 35° C. or more, 36° C. or more, 37° C. or more, 38° C. or more, 39° C. or more, or 40° C. or more). In some examples, the temperature of the air can be 50° C. or less (e.g., 45° C. or less, 40° C. or less, 39° C. or less, 38° C. or less, 37° C. or less, 36° C. or less, 35° C. or less, 34° C. or less, 33° C. or less, 32° C. or less, 31° C. or less, 30° C. or less, 25° C. or less, 20° C. or less, 15° C. or less, 10° C. or less, 5° C. or less, 0° C. or less, −5° C. or less, −10° C. or less, −15° C. or less −16° C. or less, or −17° C. or less). The temperature of the air can range from any of the minimum values described above to any of the maximum values described above. For example, the temperature of the air can be from −25° C. to 50° C. (e.g., from −25° C. to 15° C., from 15° C. to 50° C., from −25° C. to −15° C., from −15° C. to 0° C., from 0° C. to 25° C., from 25° C. to 50° C., from 0° C. to 30° C., or from 32° C. to 38° C.).

The average particle size of the dry particles comprising the precursor, the average particle size of the dry particles comprising the proton-generating species, the presence or absence of air flowing through the filter system, the amount of time the air flows through the filter system, the amount of humidity in the air, the amount of precursor in the dry particles comprising the precursor, the amount of proton-generating species in the dry particles comprising the proton-generating species, the identity of the precursor, the identity of the proton-generating species, the amount of the dry particles comprising the precursor, the amount of the dry particles comprising the proton-generating species, the total number of layers in the layered bed, the average thickness of each of the layers of dry particles comprising the precursor in the layered bed, the average thickness of each of the layers of dry particles comprising the proton-generating species in the layered bed, the temperature of the air, the amount of base used to treat the porous carrier impregnated with the precursor, or a combination thereof, can be selected to control the total amount of treatment gas produced and/or the rate at which the treatment gas is produced.

In some examples, the air directed through the filter system comprises a first component in a first amount before entering the filter system. The filter system can, for example, reduce the amount of the first component in the air, such that the air exiting the filter system has a lower amount of the first component relative to the air entering the filter system. In some examples, the filter system substantially removes the first component from the air. In some examples, the first component comprises a pathogen and the filter system reduces the activity (e.g., contagiousness and/or infectiousness) of the pathogen. In some examples, the first component comprises an organic molecule and the first filter oxidizes the first component.

The first component can, for example, comprise a toxin, a contaminant, a warfare agent (e.g., a chemical or biological warfare agent), or a combination thereof. In some examples, the first component comprises an organic molecule, a biological agent (e.g., bacteria, virus, protozoan, parasite, fungus, biological warfare agent, or combination thereof), or a combination thereof. In some examples, the first component comprises a pathogen, such as an infectious microbe (e.g., bacteria, virus, fungi, protozoa, etc.).

Examples of viruses include both DNA viruses and RNA viruses. Exemplary viruses can belong to the following non-exclusive list of families Adenoviridae, Arenaviridae, Astroviridae, Baculoviridae, Barnaviridae, Betaherpesvirinae, Birnaviridae, Bromoviridae, Bunyaviridae, Caliciviridae, Chordopoxvirinae, Circoviridae, Comoviridae, Coronaviridae, Cystoviridae, Corticoviridae, Entomopoxvirinae, Filoviridae, Flaviviridae, Fuselloviridae, Geminiviridae, Hepadnaviridae, Herpesviridae, Gammaherpesvirinae, Inoviridae, Iridoviridae, Leviviridae, Lipothrixviridae, Microviridae, Myoviridae, Nodaviridae, Orthomyxoviridae, Papovaviridae, Paramyxoviridae, Paramyxovirinae, Partitiviridae, Parvoviridae, Phycodnaviridae, Picornaviridae, Plasmaviridae, Pneumovirinae, Podoviridae, Polydnaviridae, Potyviridae, Poxviridae, Reoviridae, Retroviridae, Rhabdoviridae, Sequiviridae, Siphoviridae, Tectiviridae, Tetraviridae, Togaviridae, Tombusviridae, and Totiviridae.

Specific examples of viruses include, but are not limited to, Mastadenovirus, Adenovirus, Human adenovirus 2, Aviadenovirus, African swine fever virus, classical swine fever virus, arenavirus, Lymphocytic choriomeningitis virus, Ippy virus, Lassa virus, Arterivirus, Human astrovirus 1, Nucleopolyhedrovirus, Autographa californica nucleopolyhedrovirus, Granulovirus, Plodia interpunctella granulovirus, Badnavirus, Commelina yellow mottle virus, Rice tungro bacilliform, Barnavirus, Mushroom bacilliform virus, Aquabirnavirus, Infectious pancreatic necrosis virus, Avibirnavirus, Infectious bursal disease virus, Entomobirnavirus, Drosophila X virus, Alfamovirus, Alfalfa mosaic virus, Ilarvirus, Ilarvirus Subgroups 1-10, Tobacco streak virus, Bromovirus, Brome mosaic virus, Cucumovirus, Cucumber mosaic virus, Bhanja virus Group, Kaisodi virus, Mapputta virus, Okola virus, Resistencia virus, Upolu virus, Yogue virus, Bunyavirus, Anopheles A virus, Anopheles B virus, Bakau virus, Bunyamwera virus, Bwamba virus, C virus, California encephalitis virus, Capim virus, Gamboa virus, Guama virus, Koongol virus, Minatitlan virus, Nyando virus, Olifantsvlei virus, Patois virus, Simbu virus, Tete virus, Turlock virus, Hantavirus, Hantaan virus, Nairovirus, Crimean-Congo hemorrhagic fever virus, Dera Ghazi Khan virus, Hughes virus, Nairobi sheep disease virus, Qalyub virus, Sakhalin virus, Thiafora virus, Crimean-congo hemorrhagic fever virus, Phlebovirus, Sandfly fever virus, Bujaru complex, Candiru complex, Chilibre complex, Frijoles complex, Punta Toro complex, Rift Valley fever complex, Salehabad complex, Sandfly fever Sicilian virus, Uukuniemi virus, Uukuniemi virus, Tospovirus, Tomato spotted wilt virus, Calicivirus, Vesicular exanthema of swine virus, Capillovirus, Apple stem grooving virus, Carlavirus, Carnation latent virus, Caulimovirus, Cauliflower mosaic virus, Circovirus, Chicken anemia virus, Closterovirus, Beet yellows virus, Comovirus, Cowpea mosaic virus, Fabavirus, Broad bean wilt virus 1, Nepovirus, Tobacco ringspot virus, Coronavirus, Avian infectious bronchitis virus, Bovine coronavirus, Canine coronavirus, Feline infectious peritonitis virus, Human coronavirus 299E, Human coronavirus OC43, Murine hepatitis virus, Porcine epidemic diarrhea virus, Porcine hemagglutinating encephalomyelitis virus, Porcine transmissible gastroenteritis virus, porcine reproductive and respiratory syndrome virus, Rat coronavirus, Turkey coronavirus, Rabbit coronavirus, Torovirus, Berne virus, Breda virus, Corticovirus, Alteromonas phage PM2, Pseudomonas Phage phi6, Deltavirus, Hepatitis delta virus, Hepatitis D virus, Hepatitis E virus, Dianthovirus, Carnation ringspot virus, Red clover necrotic mosaic virus, Sweet clover necrotic mosaic virus, Enamovirus, Pea enation mosaic virus, Filovirus, Marburg virus, Ebola virus, Ebola virus Zaire, Flavivirus, Yellow fever virus, Tick-borne encephalitis virus, Rio Bravo Group, Japanese encephalitis, Tyuleniy Group, Ntaya Group, Uganda S Group, Dengue Group, Modoc Group, Pestivirus, Bovine diarrhea virus, Hepatitis C virus, Furovirus, Soil-borne wheat mosaic virus, Beet necrotic yellow vein virus, Fusellovirus, Sulfobolus virus 1, Subgroup I, II, and III geminivirus, Maize streak virus, Beet curly top virus, Bean golden mosaic virus, Orthohepadnavirus, Hepatitis B virus, Avihepadnavirus, Alphaherpesvirinae, Simplexvirus, Human herpesvirus 1, Herpes Simplex virus-1, Herpes Simplex virus-2, Varicellovirus, Varicella-Zoster virus, Epstein-Barr virus, Human herpesvirus 3, Cytomegalovirus, Human herpesvirus 5, Muromegalovirus, Mouse cytomegalovirus 1, Roseolovirus, Human herpesvirus 6, Lymphocryptovirus, Human herpesvirus 4, Rhadinovirus, Ateline herpesvirus 2, Hordeivirus, Barley stripe mosaic virus, Hypoviridae, Hypovirus, Cryphonectria hypovirus 1-EP713, Idaeovirus, Raspberry bushy dwarf virus, Inovirus, Coliphage fd, Plectrovirus, Acholeplasma phage L51, Iridovirus, Chilo iridescent virus, Chloriridovirus, Mosquito iridescent virus, Ranavirus, Frog virus 3, Lymphocystivirus, Lymphocystis disease virus flounder isolate, Goldfish virus 1, Levivirus, Enterobacteria phage MS2, Allolevirus, Enterobacteria phage Qbeta, Lipothrixvirus, Thermoproteus virus 1, Luteovirus, Barley yellow dwarf virus, Machlomovirus, Maize chlorotic mottle virus, Marafivirus, Maize rayado fino virus, Microvirus, Coliphage phiX174, Spiromicrovirus, Spiroplasma phage 4, Bdellomicrovirus, Bdellovibrio phage MAC 1, Chlamydiamicrovirus, Chlamydia phage 1, T4-like phages, coliphage T4, Necrovirus, Tobacco necrosis virus, Nodavirus, Nodamura virus, Influenzavirus A, B and C, Thogoto virus, Polyomavirus, Murine polyomavirus, Papillomavirus, Rabbit (Shope) Papillomavirus, Paramyxovirus, Human parainfluenza virus 1, Morbillivirus, Measles virus, Rubulavirus, Mumps virus, Pneumovirus, Human respiratory syncytial virus, Partitivirus, Gaeumannomyces graminis virus 019/6-A, Chrysovirus, Penicillium chrysogenum virus, Alphacryptovirus, White clover cryptic viruses 1 and 2, Betacryptovirus, Parvovirinae, Parvovirus, Minute mice virus, Erythrovirus, B19 virus, Dependovirus, Adeno-associated virus 1, Densovirinae, Densovirus, Junonia coenia densovirus, Iteravirus, Bombyx mori virus, Contravirus, Aedes aegypti densovirus, Phycodnavirus, 1-Paramecium bursaria Chlorella NC64A virus group, Paramecium bursaria chlorella virus 1, 2-Paramecium bursaria Chlorella Pbi virus, 3-Hydra viridis Chlorella virus, Enterovirus, Poliovirus, Human poliovirus 1, Rhinovirus, Human rhinovirus 1A, Hepatovirus, Human hepatitis A virus, Cardiovirus, Encephalomyocarditis virus, Aphthovirus, Foot-and-mouth disease virus, Plasmavirus, Acholeplasma phage L2, Podovirus, Coliphage T7, Ichnovirus, Campoletis sonorensis virus, Bracovirus, Cotesia melanoscela virus, Potexvirus, Potato virus X, Potyvirus, Potato virus Y, Rymovirus, Ryegrass mosaic virus, Bymovirus, Barley yellow mosaic virus, Orthopoxvirus, Vaccinia virus, Parapoxvirus, Orf virus, Avipoxvirus, Fowlpox virus, Capripoxvirus, Sheep pox virus, Leporipoxvirus, Myxoma virus, Suipoxvirus, Swinepox virus, Molluscipoxvirus, Molluscum contagiosum virus, Yatapoxvirus, Yaba monkey tumor virus, Entomopoxviruses A, B, and C, Melolontha entomopoxvirus, Amsacta moorei entomopoxvirus, Chironomus luridus entomopoxvirus, Orthoreovirus, Mammalian orthoreoviruses, reovirus 3, Avian orthoreoviruses, Orbivirus, African horse sickness viruses 1, Bluetongue viruses 1, Changuinola virus, Corriparta virus, Epizootic hemarrhogic disease virus 1, Equine encephalosis virus, Eubenangee virus group, Lebombo virus, Orungo virus, Palyam virus, Umatilla virus, Wallal virus, Warrego virus, Kemerovo virus, Rotavirus, Groups A-F rotaviruses, Simian rotavirus SA11, Coltivirus, Colorado tick fever virus, Aquareovirus, Groups A-E aquareoviruses, Golden shiner virus, Cypovirus, Cypovirus types 1-12, Bombyx mori cypovirus 1, Fijivirus, Fijivirus groups 1-3, Fiji disease virus, Fijivirus groups 2-3, Phytoreovirus, Wound tumor virus, Oryzavirus, Rice ragged stunt, Mammalian type B retroviruses, Mouse mammary tumor virus, Mammalian type C retroviruses, Murine Leukemia Virus, Reptilian type C oncovirus, Viper retrovirus, Reticuloendotheliosis virus, Avian type C retroviruses, Avian leukosis virus, Type D Retroviruses, Mason-Pfizer monkey virus, BLV-HTLV retroviruses, Bovine leukemia virus, Lentivirus, Bovine lentivirus, Bovine immunodeficiency virus, Equine lentivirus, Equine infectious anemia virus, Feline lentivirus, Feline immunodeficiency virus, Canine immunodeficiency virus Ovine/caprine lentivirus, Caprine arthritis encephalitis virus, Visna/maedi virus, Primate lentivirus group, Human immunodeficiency virus 1, Human immunodeficiency virus 2, Human immunodeficiency virus 3, Simian immunodeficiency virus, Spumavirus, Human spuma virus, Vesiculovirus, Vesicular stomatitis virus, Vesicular stomatitis Indiana virus, Lyssavirus, Rabies virus, Ephemerovirus, Bovine ephemeral fever virus, Cytorhabdovirus, Lettuce necrotic yellows virus, Nucleorhabdovirus, Potato yellow dwarf virus, Rhizidiovirus, Rhizidiomyces virus, Sequivirus, Parsnip yellow fleck virus, Waikavirus, Rice tungro spherical virus, Lambda-like phages, Coliphage lambda, Sobemovirus, Southern bean mosaic virus, Tectivirus, Enterobacteria phage PRD1, Tenuivirus, Rice stripe virus, Nudaurelia capensis beta-like viruses, Nudaurelia beta virus, Nudaurelia capensis omega-like viruses, Nudaurelia omega virus, Tobamovirus, Tobacco mosaic virus (vulgare strain; ssp. NC82 strain), Tobravirus, Tobacco rattle virus, Alphavirus, Sindbis virus, Rubivirus, Rubella virus, Tombusvirus, Tomato bushy stunt, virus, Carmovirus, Carnation mottle virus, Turnip crinkle virus, Totivirus, Saccharomyces cerevisiae virus, Giardiavirus, Giardia lamblia virus, Leishmaniavirus, Leishmania brasiliensis virus 1-1, Trichovirus, Apple chlorotic leaf spot virus, Tymovirus, Turnip yellow mosaic virus, Umbravirus, Carrot mottle virus, Variola virus, Coxsackie virus, Dengue virus, Rous sarcoma virus, Zika virus, Lassa fever virus, Eastern Equine Encephalitis virus, Venezuelan equine encephalitis virus, Western equine encephalitis virus, St. Louis Encephalitis virus, Murray Valley fever virus, West Nile virus, Human T-cell Leukemia virus type-1, echovirus, norovirus, and feline calicivirus (FCV).

In some examples, the virus can comprise an influenza virus, a coronavirus, or a combination thereof. Examples of influenza viruses include, but are not limited to, Influenzavirus A (including the H1N1, H2N2, H3N2, H5N1, H7N7, H1N2, H9N2, H7N2, H7N3, H10N7, H7N9, and H6N1 serotypes), Influenzavirus B, Influenzavirus C, and Influenzavirus D. Examples of coronaviruses include, but are not limited to, avian coronavirus (IBV), porcine epidemic diarrhea virus (PEDV), porcine respiratory coronavirus (PRCV), porcine reproductive and respiratory syndrome (PRRS) virus, transmissible gastroenteritis virus (TGEV), feline coronavirus (FCoV), feline infectious peritonitis virus (FIPV), feline enteric coronavirus (FECV), canine coronavirus (CCoV), rabbit coronavirus (RaCoV), mouse hepatitis virus (MHV), rat coronavirus (RCoV), sialodacryadenitis virus of rats (SDAV), bovine coronavirus (BCoV), bovine enterovirus (BEV), porcine coronavirus HKU15 (PorCoV HKU15), Porcine epidemic diarrhea virus (PEDV), porcine hemagglutinating encephalomyelitis virus (HEV), turkey bluecomb coronavirus (TCoV), human coronavirus (HCoV)-229E, HCoV-OC43, HCoV-HKU1, HCoV-NL63, Severe Acute Respiratory Syndrome (SARS)-Coronavirus (CoV)(SARS-CoV), Severe Acute Respiratory Syndrome (SARS)-Coronavirus (CoV)-2 (SARS-CoV-2), and middle east respiratory syndrome (MERS) coronavirus (CoV) (MERS-CoV). In some examples, the virus can comprise Severe Acute Respiratory Syndrome (SARS)-Coronavirus (CoV)-2 (SARS-CoV-2).

Specific examples of bacteria include, but are not limited to, Mycobacterium tuberculosis, Mycobacterium bovis, Mycobacterium bovis strain BCG, BCG substrains, Mycobacterium avium, Mycobacterium intracellular, Mycobacterium africanum, Mycobacterium kansasii, Mycobacterium marinum, Mycobacterium ulcerans, Mycobacterium avium subspecies paratuberculosis, Nocardia asteroides, other Nocardia species, Legionella pneumophila, other Legionella species, Acetinobacter baumanii, Salmonella typhi, Salmonella enterica, Salmonella Typhimurium, other Salmonella species, Shigella boydii, Shigella dysenteriae, Shigella sonnei, Shigella flexneri, other Shigella species, Yersinia pestis, Pasteurella haemolytica, Pasteurella multocida, other Pasteurella species, Actinobacillus pleuropneumoniae, Listeria monocytogenes, Listeria ivanovii, Brucella abortus, Brucella suis, Brucella melitensis, other Brucella species, Cowdria ruminantium, Borrelia burgdorferi, Bordetella avium, Bordetella pertussis, Bordetella bronchiseptica, Bordetella trematum, Bordetella hinzii, Bordetella pteri, Bordetella parapertussis, Bordetella ansorpii, other Bordetella species, Burkholderia mallei, Burkholderia psuedomallei, Burkholderia cepacian, Chlamydia pneumoniae, Chlamydia trachomatis, Chlamydia psittaci, Coxiella burnetii, rickettsia rickettsia, rickettsia prowazekii, rickettsia typhi, other Rickettsial species, Ehrlichia species, Staphylococcus aureus, Staphylococcus epidermidis, Streptococcus pneumoniae, Streptococcus pyogenes, Streptococcus agalactiae, Streptococcus uberis, Escherichia coli, Vibrio cholerae, Vibrio parahaemolyticus, Campylobacter species, Neiserria meningitidis, Neiserria gonorrhea, Pseudomonas aeruginosa, other Pseudomonas species, Haemophilus influenzae, Haemophilus ducreyi, other Hemophilus species, Clostridium tetani, Clostridium difficile, Clostridium botulinum, Clostridium perfringens, other Clostridium species, Yersinia enterolitica, yersinia pestis, other Yersinia species, Mycoplasma species, Bacillus anthracis, Bacillus abortus, other Bacillus species, Corynebacterium diptheriae, Corynebacterium bovis, Francisella tularensis, Chlamydophila psittaci, Campylocavter jejuni, Enterobacter aerogenes, Klebsiella pneumoniae, Klebsiella oxytoca, Proteus spp., Serratia marcescens, Trueperella pyogenes, and Vibria vulnificus.

Specific examples of fungi include, but are not limited to, Candida albicans, Cryptococcus neoformans, Histoplama capsulatum, Aspergillus niger, Aspergillus oryzae, Aspergillus fumigatus, Coccidiodes immitis, Paracoccidiodes brasiliensis, Blastomyces dermitidis, Pneumocystis carinii, Penicillium marneffi, Alternaria alternate, coccidioides immitits, Fusarium oxysporum, Geotrichum candidum, and Histoplasma capsulatum.

Specific examples of parasites include, but are not limited to, Toxoplasma gondii, Plasmodium falciparum, Plasmodium vivax, Plasmodium malariae, other Plasmodium species, Entamoeba histolytica, Naegleria fowleri, Rhinosporidium seeberi, Giardia lamblia, Enterobius vermicularis, Enterobius gregorii, Ascaris lumbricoides, Ancylostoma duodenale, Necator americanus, Cryptosporidium spp., Trypanosoma brucei, Trypanosoma cruzi, Leishmania major, other Leishmania species, Diphyllobothrium latum, Hymenolepis nana, Hymenolepis diminuta, Echinococcus granulosus, Echinococcus multilocularis, Echinococcus vogeli, Echinococcus oligarthrus, Diphyllobothrium latum, Clonorchis sinensis; Clonorchis viverrini, Fasciola hepatica, Fasciola gigantica, Dicrocoelium dendriticum, Fasciolopsis buski, Metagonimus yokogawai, Opisthorchis viverrini, Opisthorchis felineus, Clonorchis sinensis, Trichomonas vaginalis, Acanthamoeba species, Schistosoma intercalatum, Schistosoma haematobium, Schistosoma japonicum, Schistosoma mansoni, other Schistosoma species, Trichobilharzia regenti, Trichinella spiralis, Trichinella britovi, Trichinella nelsoni, Trichinella nativa, and Entamoeba histolytica.

In some examples, the first component can comprise a chemical or biological warfare agent. Examples of chemical warfare agents include, but are not limited to, nerve agents (e.g., sarin, soman, cyclosarin, tabun, Ethyl ({2-[bis(propan-2-yl)amino]ethyl}sulfanyl)(methyl)phosphinate (VX), O-pinacolylmethylphosphonofluoridate), vesicating or blistering agents (e.g., mustards, lewisite), respiratory agents (e.g., chlorine, phosgene, diphosgene), cyanides, antimiscarinic agents (e.g., anticholinergic compounds), opioid agents, lachrymatory agents (e.g., a-cholorotoluene, benzyl bromide, boromoacetone (BA), boromobenzylcyanide (CA), capsaicin (OC), chloracetophenone (MACE), chlormethyl choloroformate, dibenoxazepine (CR), ethyl iodoacetate, ortho-chlorobenzlidene malonitrile (CS), trichloromethyl chloroformate, xylyl bromide), and vomiting agents (e.g., adamsite (DM), diphenylchloroarsine (DA), diphenylcanoarsine (DC)). Biological warfare agents include, but are not limited to bacteria (e.g., Bacillus anthracis, Bacillus abortus, Brucella suis, Vibrio cholerae, Corynebacterium diptheriae, Shigella dysenteriae, Escherichia coli, burkholderia mallei, listeria monocytogenes, Burkholderia pseudomallei, yersinia pestis, Francisella tularensis, Chlamydophila psittaci, Coxiella burnetii, rickettsia, rickettsia prowazekii, rickettsia typhi), viruses (e.g., Eastern equine virus, Venezuelan equine encephalitis virus, Western equine encephalitis virus, Japanese encephalitis virus, Rift Valley fever virus, Variola virus, Yellow Fever virus, Ebola virus, Marburg virus, coronaviruses), protozoa, parasites, fungi (coccidioides immitis), pathogens, toxins, and biotoxins (Abrin, Botulinum toxin, Ricin, Saxitoxin, Staphylococcal enterotoxin B, tetrodotoxin, trichothecene mycotoxins).

Also disclosed herein are methods of use of any of the filter systems disclosed herein.

For example, also disclosed herein are methods of use of any of the filter systems disclosed herein for treating air. For example, the air exiting the filter system is treated relative to the air entering the filter system.

In some examples, the air directed through the filter system comprises a first component in a first amount before entering the filter system. The methods can, for example, reduce the amount of the first component in the air, such that the air exiting the filter system has a lower amount of the first component relative to the air entering the filter system. In some examples, the methods can substantially remove the first component from the air. In some examples, the first component comprises a pathogen and the methods can reduce the activity (e.g., contagiousness and/or infectiousness) of the pathogen. In some examples, the first component comprises an organic molecule and the methods can comprise oxidizing the first component. The first component can, for example, comprise a toxin, a contaminant, a warfare agent (e.g., a chemical or biological warfare agent), or a combination thereof. In some examples, the first component comprises an organic molecule, a biological agent (e.g., bacteria, virus, protozoan, parasite, fungus, biological warfare agent, or combination thereof), or a combination thereof. In some examples, the first component comprises a pathogen, such as an infectious microbe (e.g., bacteria, virus, fungi, protozoa, etc.).

In some examples, the methods can comprise reducing the transmission of bioaerosols containing infectious microbials. In some examples, the methods can comprise air purification, environmental remediation, or a combination thereof.

In some examples, the methods can comprise treating ambient air within a chamber having a volume by releasing the treatment gas generated by the media into the chamber. The chamber can, for example, be provided within a building (e.g., a room, garage, laboratory, fume hood, etc.). In some examples, the filter system releases an amount of the treatment gas into the chamber, such that the concentration of the treatment gas within the volume of the chamber is 1 ppmv or less.

The filter systems described herein can be used, for example, in a variety of respiration and filter applications, for example for military and/or industrial uses. In some examples, the filter systems can be used in gas masks, respirators, and/or other personal protection devices. For example, the personal protection devices can further comprise a material, such as a fabric. The personal protection device can, for example, comprise a mask, head covering, face shield, breathing scarf, a respiratory system, an over-garment (e.g., coat, pants, suit, gloves, foot covering, etc.), or a combination thereof. Suitable fabrics that can be combined with the filter systems disclosed herein include, but are not limited to, cotton, polyester, nylon, rayon, wool, silk, and the like.

Also disclosed herein are articles of manufacture comprising any of the filter systems disclosed herein, such as respirators, gas masks, personal protection devices, or a combination thereof.

The filter systems, respirators, gas masks, and/or personal protection devices described herein can, for example, be used for military, homeland security, first responder, civilian, and/or industrial applications. The filter systems, respirators, gas masks, and/or personal protection devices described herein can, for example, provide protection from exposure to harmful chemical and/or biological agents.

The filter systems, respirators, gas masks, and/or personal protection devices described herein are suitable for use by a subject in need of protection, such as a human, a service animal, a working animal (e.g., a law-enforcement animal, a cadaver animal, a search-and-rescue animal, a military animal, a detection animal) and the like.

In some examples, the filter systems, respirators, gas masks, and/or personal protection devices described herein are suitable for use in animal industry or veterinary industry applications.

Also disclosed herein are methods for of treating, preventing, or ameliorating a disease or disorder in a subject in need thereof, the methods comprising administering to the subject a therapeutically effect amount of the treatment gas generated by any of the filter systems disclosed herein.

For example, disclosed herein are methods for of treating a disease or disorder in a subject in need thereof, the methods comprising administering to the subject a therapeutically effect amount of the treatment gas generated by any of the filter systems disclosed herein.

For example, the treatment gas described herein can be useful for treating a disease or disorder in humans, e.g., pediatric and geriatric populations, and in animals, e.g., veterinary applications. The disclosed methods can optionally include identifying a patient who is or may be in need of treatment of a disease or disorder.

In some examples, the method comprises delivering a therapeutically effective amount of the treatment gas to at least a portion of the respiratory tract of the subject. For example, the subject can inhale the therapeutically effective amount of the treatment gas.

In some examples, the filter system is part of a respirator or mask configured to deliver a therapeutically effect amount of the treatment gas to at least a portion of the respiratory tract of the subject.

In some examples, the method comprises treating ambient air within a chamber having a volume by releasing the treatment gas generated by the media into the chamber, and the subject is located within the chamber, such that the subject inhales the treated ambient air within the chamber.

In some examples, the disease or disorder comprises an infection, such as with an infectious microbe (e.g., bacteria, virus, fungi, protozoa, etc.). In some examples, the disease or disorder comprises a respiratory infection. In some examples, the disease or disorder comprises an infection with a coronavirus, influenza virus, or a combination thereof.

The methods of treatment of the disease or disorder described herein can further include treatment with one or more additional agents. The one or more additional agents and the treatment gas as described herein can be administered in any order, including simultaneous administration, as well as temporally spaced order of up to several days apart. The methods can also include more than a single administration of the one or more additional agents and/or the treatment gas as described herein. The administration of the one or more additional agents and the treatment gas as described herein can be by the same or different routes. When treating with one or more additional agents, the treatment gas as described herein can be combined into a pharmaceutical composition that includes the one or more additional agents.

In some examples, the treatment gas delivered or administered to the subject can have a concentration of 1 ppmv or less.

It is understood, however, that the specific dose level for any particular subject will depend upon a variety of factors. Such factors include the age, body weight, general health, sex, and diet of the subject. Other factors include the time and route of administration, rate of excretion, drug combination, and the type and severity of the particular disease or disorder.

The methods and treatment gases as described herein are useful for both prophylactic and therapeutic treatment. As used herein the term treating or treatment includes prevention; delay in onset; diminution, eradication, or delay in exacerbation of signs or symptoms after onset; and prevention of relapse. For prophylactic use, a therapeutically effective amount of the treatment gas as described herein are administered to a subject prior to onset (e.g., before obvious signs of the disease or disorder), during early onset (e.g., upon initial signs and symptoms of the disease or disorder), or after an established development of the disease or disorder. Prophylactic administration can occur for several days to years prior to the manifestation of symptoms of a disease or disorder. Therapeutic treatment involves administering to a subject a therapeutically effective amount of the treatment gas as described herein after the disease or disorder is diagnosed.

In vivo application of the disclosed treatment gas and compositions containing them, can be accomplished by any suitable method and technique presently or prospectively known to those skilled in the art. For example, the disclosed treatment gas can be formulated in a physiologically- or pharmaceutically-acceptable form and administered by any suitable route known in the art including, for example, oral and nasal routes of administration. Administration of the disclosed treatment gas can be a single administration, or at continuous or distinct intervals as can be readily determined by a person skilled in the art.

The compounds disclosed herein can be formulated according to known methods for preparing pharmaceutically acceptable compositions. Formulations are described in detail in a number of sources which are well known and readily available to those skilled in the art. For example, Remington's Pharmaceutical Science by E. W. Martin (1995) describes formulations that can be used in connection with the disclosed methods. In general, the compounds disclosed herein can be formulated such that an effective amount of the compound is combined with a suitable excipient in order to facilitate effective administration of the compound.

The compositions can also include conventional pharmaceutically-acceptable carriers and diluents which are known to those skilled in the art. The pharmaceutical carrier employed can be, for example, a gas. Examples of gaseous carriers include carbon dioxide and nitrogen.

Useful dosages of the compounds and agents and pharmaceutical compositions disclosed herein can be determined by comparing their in vitro activity, and in vivo activity in animal models. Methods for the extrapolation of effective dosages in mice, and other animals, to humans are known to the art.

The dosage ranges for the administration of the compositions are those large enough to produce the desired effect in which the symptoms or disorder are affected. The dosage should not be so large as to cause adverse side effects, such as unwanted cross-reactions, anaphylactic reactions, and the like. Generally, the dosage will vary with the age, condition, sex and extent of the disease in the patient and can be determined by one of skill in the art. The dosage can be adjusted by the individual physician in the event of any counterindications. Dosage can vary, and can be administered in one or more dose administrations daily, for one or several days.

Also disclosed are kits that comprise the filter system disclosed herein in one or more containers. The disclosed kits can optionally include pharmaceutically acceptable carriers and/or diluents. In one embodiment, a kit includes one or more other components, adjuncts, or adjuvants as described herein. In one embodiment, a kit includes instructions or packaging materials that describe how to administer a compound or composition of the kit. Containers of the kit can be of any suitable material, e.g., glass, plastic, metal, etc., and of any suitable size, shape, or configuration.

The kits can also comprise compounds and/or products co-packaged, co-formulated, and/or co-delivered with other components. For example, a drug manufacturer, a drug reseller, a physician, a compounding shop, or a pharmacist can provide a kit comprising a disclosed compound and/or product and another component for delivery to a patient.

It is contemplated that the disclosed kits can be used in connection with the disclosed methods of making, the disclosed methods of using, and/or the disclosed compositions.

The examples below are intended to further illustrate certain aspects of the methods and compounds described herein and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1

A study was performed to determine the virucidal efficacy of Chlorine Dioxide Media Filter treatment on aerosolized and surface deposited bacteriophage MS2 (ATCC: 15597-B1) in a temperature and humidity controlled 742 cubic foot sealed chamber; temperature was maintained at 24-26° C. and humidity at 40-50%.

Three sterile open to air petri-dishes were placed at three separate locations near self-closing sampling ports within the room. The petri-dishes were accessible through the self-closing sampling ports in order to allow retrieval without entering the room. Additionally, one sterile open to air petri-dish was placed at three separate locations on the floor within the room; these petri-dishes were retrieved from the room at the final post exposure time point.

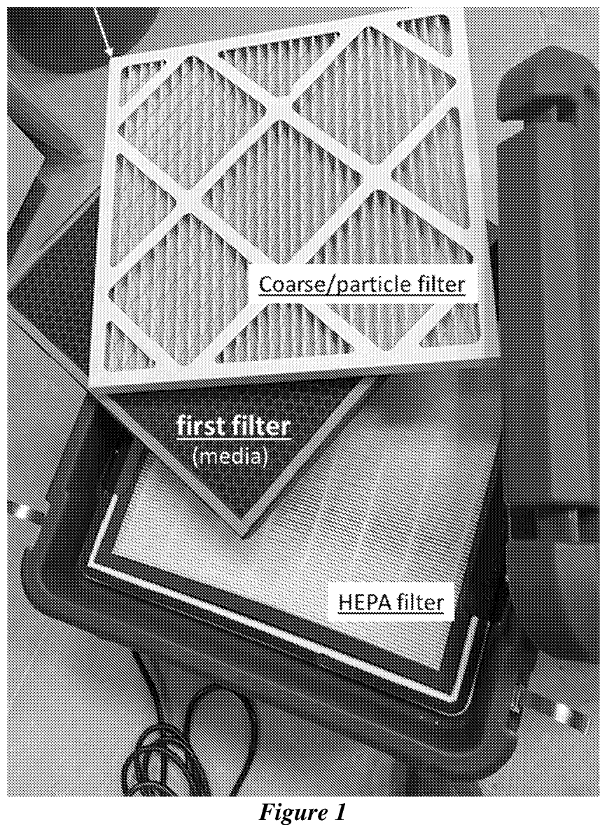

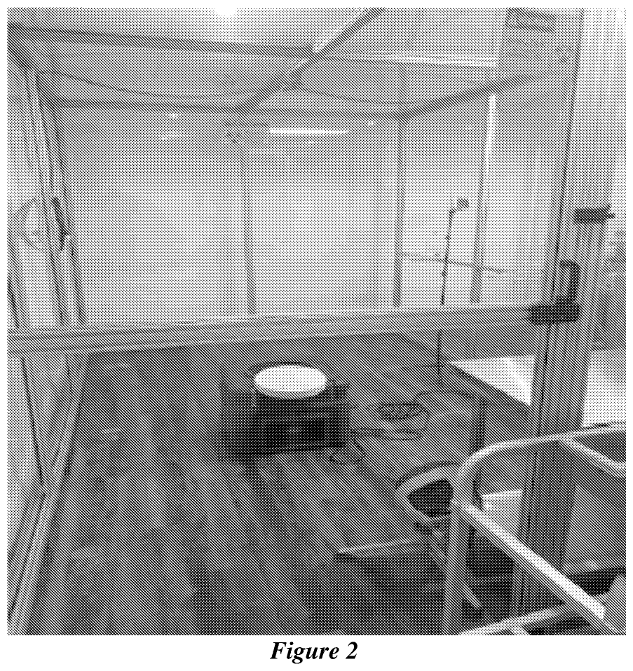

The Chlorine Dioxide Media Filter (FIG. 1) was placed in the center of the chamber (FIG. 2), the chamber was sealed, and the unit was operated for 16 hours. MS2 (ATCC: 15597-B1) was used as a conservative surrogate for human viruses. MS2 (ATCC: 15597-B1) was diluted in sterile Phosphate Buffered Saline (PBS) and added to a Single Jet Atomizer 9302 (TSI Incorporated, USA). The Atomizer was pressurized to 35.0 PSI to inject the virus into the room atmosphere. A NIST traceable timer was started. After 75-minutes of aerosolization time, the Atomizer was turned off. The Chlorine Dioxide Media Filter was kept on throughout the aerosolization process and for the following 180 minutes following cessation of aerosolization.

A BioSampler liquid impinger (SKC Ltd.) containing 20 mL of sterile PBS with sodium thiosulfate (final conc. 0.01%) was used to sample 120 liters of the chamber air through an air sampling port located midway through the side of the chamber. Petri dishes from the respective three self-closing sampling ports were also retrieved at indicated times following cessation of aerosolization. The collected samples represent the T=0 event samples. The petri dish sample collection procedure was repeated again at each of the indicated time points. Additionally, AirChek Sampler (SKC Inc.) connected to two Midget Impingers with Frit (SKC Inc.) each containing 25 mL of 0.02% KI Solution was used to sample chamber's air for 30 minutes at a flowrate of 1 LPM through an air sampling port located at the front side of the chamber. Following, the potassium iodide solution was transferred into two separate sterile containers to be analyzed for chlorine dioxide concentration. Following the retrieval of each open to air petri dish, 20 mL of PBS containing sodium thiosulfate (final conc. 0.01%) was added to each dish, the dish covered, the solution homogenized by gentle swirling for 5 minutes, and then poured into a sterile 50-mL centrifuge tube containing 0.1 mL of 10× TSB. A positive control consisting of directly inoculated petri plate and negative control consisting of unexposed petri plate were processed similarly. Positive and negative controls were performed to provide quality control and reference data as per laboratory standard accredited ISO17025:2017 methodology. All collected samples were analyzed on the day of the study undiluted and at various dilutions in replicates of at least 2. MS2 (ATCC: 15597-B1) virus was analyzed and enumerated as Plaque Forming Units (PFU) as per EPA 1602. The respective percent decay rate was determined based on the recovery of the controls and test samples. All equipment and supplies were validated to or were calibrated to NIST traceable standards. All QC were within method acceptance limit. No general environmental conditions are specified in the standard or have been identified that could affect the test results or measurements.

The results of the tests are shown in Table 1 and Table 2 below.

Additional tests were performed using an air filtration system as disclosed herein, which can, for example, be integrated into standard housing for off shelf fans and blowers. The results are summarized in Table 3.

TABLE 1
Chlorine dioxide filter media filter virucidal efficacy on aerosolized
MS2 (ATCC: 15597-B1) - Virus bioaerosol decay rate testing.

| | | Elapsed Time of | | Concentration of Virus in |
|---|---|---|---|---|
| | Aerosolization | Continual Chlorine | | Air After Chlorine Dioxide |
| Sampling | Time Prior to | Dioxide Media Filter | | Filter Media Treatment at |
| Location | Start of Sample | Treatment Post Cessation | | the Indicated Elapsed Time |
| (Air)* | Collection | of Aerosolization | | (PFU/Liter Air) |
| Air Samples | | 0 | Minutes | 7.5E+00 |
| @ B | 75 Minutes | 90 | Minutes | <0.08 |
| | | 180 | Minutes | <0.08 |

TABLE 2
Chlorine dioxide filter media filter virucidal efficacy on
MS2 (ATCC: 15597-B1) Virus deposited onto Petri plates.

| | | | | Concentration of Virus |
|---|---|---|---|---|
| | | Elapsed Time of | | Present on Petri Dish after |
| | Aerosolization | Continual Chlorine | | Chlorine Dioxide Filter |
| Sampling | Time Prior to | Dioxide Media Filter | | Media Treatment at the |
| Location | Start of Sample | Treatment Post Cessation | | Indicated Elapsed Time |
| (Surface)* | Collection | of Aerosolization | | (PFU/Petri dish)** |
| Wall Shelf | | 0 | Minutes | 9.1E+00 |
| @ A | | 90 | Minutes | <9.1 |
| | | 180 | Minutes | <9.1 |
| floor @ A | | | | <9.1 |
| Wall Shelf | | 0 | Minutes | 1.8E+01 |
| @ B | 75 Minutes | 90 | Minutes | <9.1 |
| | | 180 | Minutes | <9.1 |
| floor @ B | | | | <9.1 |
| Wall Shelf | | 0 | Minutes | 2.7E+01 |
| @ C | | 90 | Minutes | <9.1 |
| | | 180 | Minutes | <9.1 |
| floor @ C | | | | <9.1 |

*Sample Location A is located at the front side of room closest to aerosolizer, sample location B is located middle side of room, and sample location C is located at back side of room furthest away from aerosolizer. Sample location AF is located on the floor at the front side of room closest to aerosolizer, sample location BF is located on the floor at middle side of room, and sample location CF is located on the floor at back side of room furthest away from aerosolizer.

TABLE 3
Summary of test results against MS2 (ATCC: 15597-B1).

| | | | ClO₂ | Air % | Surface % |
|---|---|---|---|---|---|
| Trial | Intervention | ClO₂ Scenario | Actual | Red* | Red* |
| Control | None | Unprotected | N/A | N/A | N/A |
| Media | Chemical | Constant/Low | 0.3 ppmv | 28 | 10 |
| Release | | | | | |
| Media | Chemical | Temporary/High | 25 ppmv | 100 | 42 |
| Release | | | | | |
| Filtration | Physical and | Constant/Low | 0.3 ppmv | 100 | 100 |
| | Chemical | | | | |
| Filtration | Physical and | Temporary/Low | 0.1 ppmv | 100 | 54 |
| Sweep | Chemical | | | | |

*Percent reductions reported at 180 minutes

The systems and methods of the appended claims are not limited in scope by the specific systems and methods described herein, which are intended as illustrations of a few aspects of the claims and any systems and methods that are functionally equivalent are within the scope of this disclosure. Various modifications of the systems and methods in addition to those shown and described herein are intended to fall within the scope of the appended claims. Further, while only certain representative systems and methods, and aspects of these systems and methods are specifically described, other systems and methods and combinations of various features of the systems and methods are intended to fall within the scope of the appended claims, even if not specifically recited. Thus, a combination of steps, elements, components, or constituents can be explicitly mentioned herein; however, all other combinations of steps, elements, components, and constituents are included, even though not explicitly stated.

What is claimed is:

1. A filter system for treating air, the filter system comprising:
a first filter comprising a media;
wherein air directed to flow through the filter system contacts the first filter;
wherein the media is configured to generate a treatment gas from a precursor, such that the treatment gas is released into the flow path of the air; and
wherein the treatment gas comprises chlorine dioxide (ClO₂) and the precursor comprises a chlorine dioxide precursor, the treatment gas comprises carbon dioxide (CO₂) and the precursor comprises a carbon dioxide precursor, or a combination thereof.

2. The filter system of claim 1, further comprising a second filter sequentially arranged relative to the first filter along the direction of air flow, wherein the second filter comprises a coarse filter, a fine filter, a semi-HEPA filter, a HEPA filter, a ULPA filter, an activated carbon filter, or a combination thereof.

3. The filter system of claim 1, wherein the treatment gas comprises chlorine dioxide and the precursor comprises a chlorine dioxide precursor; wherein the treatment gas comprises carbon dioxide and the precursor comprises a carbon dioxide precursor; or a combination thereof.

4. The filter system of claim 1, wherein the media further comprises a proton generating species.

5. The filter system of claim 1, wherein the media is disposed within the first filter with an average total thickness of from 1 cm to 50 cm.

6. The filter system of claim 4, wherein the media comprises dry particles comprising the precursor and dry particles comprising the proton generating species; and
wherein the media is disposed within the first filter as a mixture of the dry particles of comprising the precursor and the dry particles comprising the proton generating species; or
wherein the media is disposed within the first filter as a layered bed comprising two or more alternating layers of the dry particles comprising the precursor and the dry particles comprising the proton-generating species.

7. The filter system of claim 1, wherein the first filter further comprises a grid structure disposed throughout the first filter.

8. The filter system of claim 7, wherein the grid structure comprises a plurality of wells and the media is disposed within the plurality of wells.

9. The filter system of claim 1, wherein the first filter further comprises a frame defining the perimeter of the first filter.

10. The filter system of claim 9, wherein the first filter further comprises a permeable layer defining a surface of the first filter, wherein the frame and the permeable layer together define a volume and the media is at least partially enclosed or contained within the volume.

11. The filter system of claim 10, wherein the permeable layer is bonded to the frame via an adhesive.

12. The filter system of claim 9, wherein the first filter further comprises a first permeable layer defining a top surface of the first filter and a second permeable layer defining a bottom surface of the first filter, such that the frame, the first permeable layer, and the second permeable layer together define a volume and the media is enclosed within the volume.

13. The filter system of claim 12, wherein the first permeable layer and the second permeable layers are bonded to the frame via an adhesive.

14. The filter system of claim 1, wherein the air exits the filter system and flows into a chamber having a volume and the first filter releases the treatment gas into the flow path of the air such that the concentration of the treatment gas within the volume of the chamber is 1 ppmv or less.

15. The filter system of claim 1, wherein the media comprises an electrostatically charged surface.

16. The filter system of claim 1, wherein the air directed through the filter system comprises a first component in a first amount before entering the filter system and wherein the first component comprises a toxin, a contaminant, a warfare agent, an organic molecule, a biological agent, a pathogen, or a combination thereof.

17. The filter system of claim 16, wherein:
the filter system reduces the amount of the first component in the air, such that the air exiting the filter system has a lower amount of the first component relative to the air entering the filter system;
the first component comprises a pathogen and the filter system reduces the activity of the pathogen;
the first component comprises an organic molecule and the first filter oxidizes the first component;
or a combination thereof.

18. A method of use of the filter system of claim 1 to treat air.

19. A method for of treating a disease or disorder in a subject in need thereof, the method comprising administering to the subject a therapeutically effect amount of the treatment gas generated by the filter system of claim 1.

20. An article of manufacture comprising the filter system of claim 1, wherein the article of manufacture comprises a respirator, a gas mask, a personal protection device, or a combination thereof.
